(19) United States
(12) Patent Application Publication
(10) Pub. No.: US 2021/0009080 A1
(43) Pub. Date: Jan. 14, 2021

(54) VEHICLE DOOR UNLOCKING METHOD, ELECTRONIC DEVICE AND STORAGE MEDIUM

(71) Applicant: SHANGHAI SENSETIME LINGANG INTELLIGENT TECHNOLOGY CO., LTD., Shanghai (CN)

(72) Inventors: Xin HU, Shanghai (CN); Cheng HUANG, Shanghai (CN)

(21) Appl. No.: 17/030,769

(22) Filed: Sep. 24, 2020

Related U.S. Application Data
(63) Continuation of application No. PCT/CN2019/121251, filed on Nov. 27, 2019.

(30) Foreign Application Priority Data
Feb. 28, 2019 (CN) 201910152568.8

(51) Int. Cl. B60R 25/25; H04N 7/18; G06K 9/00; G06T 7/50; G06K 9/62; H04W 4/02; B60R 25/30; B60R 25/31

(52) U.S. Cl. CPC B60R 25/25; B60R 2325/205; G06K 9/00288; G06K 9/00899; G06T 7/50; G06K 9/00268; G06K 9/629; H04W 4/023; B60R 25/305; B60R 25/31; G06T 2207/10028; G06T 2207/30201; G06T 2207/30252; G06T 2207/20084; G06K 2209/21; B60R 2325/101; H04N 7/188

(57) ABSTRACT

The present disclosure relates to a vehicle door unlocking method and apparatus, a system, a vehicle, an electronic device and a storage medium. The method includes: obtaining a distance between a target object outside a vehicle and the vehicle by means of at least one distance sensor provided in the vehicle; in response to the distance satisfying a predetermined condition, waking up and controlling an image collection module provided in the vehicle to collect a first image of the target object; performing face recognition based on the first image; and in response to successful face recognition, sending a vehicle door unlocking instruction to at least one vehicle door lock of the vehicle.

The present application is a. continuation of and claims priority to PCT Application No. PCT/CN2019/121251, filed on Nov. 27, 2019, which claims priority to Chinese Patent Application No. 201910152568.8, filed to the Chinese Patent Office on Feb. 28, 2019, and entitled “VEHICLE DOOR UNLOCKING METHOD AND APPARATUS, SYSTEM, VEHICLE, ELECTRONIC DEVICE AND STORAGE MEDIUM”. All the above-referenced priority documents are incorporated herein by reference in their entirety.

### TECHNICAL FIELD

The present disclosure relates to the technical field of vehicles, and in particular, to a vehicle door unlocking method and apparatus, a system, a vehicle, an electronic device and a storage medium.

### BACKGROUND

At present, users need to bring a key for unlocking the vehicle door. It is inconvenient to carry keys. In addition, there is a risk that the keys are damaged, disabled or lost.

### SUMMARY

The present disclosure provides technical solutions for vehicle door unlocking.

According to one aspect of the present disclosure, provided is a vehicle door unlocking method, including:

obtaining a distance between a target object outside a vehicle and the vehicle by means of at least one distance sensor provided in the vehicle;

in response to the distance satisfying a predetermined condition, waking up and controlling an image collection module provided in the vehicle to collect a first image of the target object;

performing face recognition based on the first image; and

in response to successful face recognition, sending a vehicle door unlocking instruction to at least one vehicle door lock of the vehicle.

According to another aspect of the present disclosure, provided is a vehicle door unlocking apparatus, including:

an obtaining module, configured to obtain a distance between a target object outside a vehicle and the vehicle by means of at least one distance sensor provided in the vehicle;

a wake-up and control module, configured to wake up and control, in response to the distance satisfying a predetermined condition, an image collection module provided in the vehicle to collect a first image of the target object;

a face recognition module, configured to perform face recognition based on the first image; and

a sending module, configured to send, in response to successful face recognition, a vehicle door unlocking instruction to at least one vehicle door lock of the vehicle.

According to another aspect of the present disclosure, provided is a vehicle-mounted face unlocking system, including: a memory, a face recognition system, an image collection module, and a human body proximity monitoring system, where the face recognition system is separately connected to the memory, the image collection module, and the human body proximity monitoring system; the human body proximity monitoring system includes a microprocessor that wakes up the face recognition system if a distance satisfies a predetermined condition and at least one distance sensor connected to the microprocessor; the face recognition system is further provided with a communication interface connected to a vehicle door domain controller; and if face recognition is successful, control information for unlocking a vehicle door is sent to the vehicle door domain controller based on the communication interface.

According to another aspect of the present disclosure, provided is a vehicle, including the foregoing vehicle-mounted face unlocking system, where the vehicle-mounted face unlocking system is connected to a vehicle door domain controller of the vehicle.

According to another aspect of the present disclosure, provided is an electronic device, including:

a processor; and

a memory configured to store processor-executable instructions;

where the processor is configured to execute the foregoing vehicle door unlocking method.

According to another aspect of the present disclosure, provided is a computer-readable storage medium, having computer program instructions stored thereon, where when the computer program instructions are executed by a processor, the foregoing vehicle door unlocking method is implemented.

According to another aspect of the present disclosure, provided is a computer program, including a computer-readable code, where when run in an electronic device, the computer-readable code is executed by a processor in the electrode device to implement the foregoing vehicle door unlocking method.

In embodiments of the present disclosure, a distance between a target object outside a vehicle and the vehicle is obtained by means of at least one distance sensor provided in the vehicle, in response to the distance satisfying a predetermined condition, an image collection module provided in the vehicle is waked up and controlled to collect a first image of the target object, face recognition is performed based on the first image, and in response to successful face recognition, a vehicle door unlocking instruction is sent to at least one vehicle door lock of the vehicle, thereby improving the convenience of vehicle door unlocking under the premise of ensuring the safety of vehicle door unlocking.

It should be understood that the above general description and the following detailed description are merely exemplary and explanatory, and are not intended to limit the present disclosure.

The other features and aspects of the present disclosure can be described more clearly according to the detailed descriptions of the exemplary embodiments in the accompanying drawings.

### BRIEF DESCRIPTION OF THE DRAWINGS

The accompanying drawings here incorporated in the specification and constituting a part of the specification illustrate the embodiments consistent with the present disclosure and are intended to explain the technical solutions of the present disclosure together with the specification.

FIG. 1 shows a flowchart of a vehicle door unlocking method according to embodiments of the present disclosure.

FIG. 2 shows a schematic diagram of a B-pillar of a vehicle.

FIG. 3 shows a schematic diagram of an installation height and a recognizable height range of a vehicle door unlocking apparatus in the vehicle door unlocking method according to embodiments of the present disclosure.

FIG. 4 shows a schematic diagram of a horizontal detection angle of an ultrasonic distance sensor and a detection radius of the ultrasonic distance sensor in the vehicle door unlocking method according to embodiments of the present disclosure.

FIG. 5a shows a schematic diagram of an image sensor and a depth sensor in the vehicle door unlocking method according to embodiments of the present disclosure.

FIG. 5b shows another schematic diagram of an image sensor and a depth sensor in the vehicle door unlocking method according to embodiments of the present disclosure.

FIG. 6 shows a schematic diagram of one example of a spoofing detection method according to embodiments of the present disclosure.

FIG. 7 shows a schematic diagram of one example of determining a spoofing detection result of a target object in a first image based on the first image and a second depth map in the spoofing detection method according to embodiments of the present disclosure.

FIG. 8 shows a schematic diagram of a depth prediction neural network in the vehicle door unlocking method according to embodiments of the present disclosure.

FIG. 9 shows a schematic diagram of a degree-of-association detection neural network in the vehicle door unlocking method according to embodiments of the present disclosure,

FIG. 10 shows an exemplary schematic diagram of updating a depth map in the vehicle door unlocking method according to embodiments of the present disclosure

FIG. 11 shows a schematic diagram of surrounding pixels in the vehicle door unlocking method according to embodiments of the present disclosure.

FIG. 12 shows another schematic diagram of surrounding pixels in the vehicle door unlocking method according to embodiments of the present disclosure.

FIG. 13 shows a block diagram of a vehicle door unlocking apparatus according to embodiments of the present disclosure.

FIG. 14 shows a block diagram of a vehicle-mounted face unlocking system according to embodiments of the present disclosure.

FIG. 15 shows a schematic diagram of a vehicle-mounted face unlocking system according to embodiments of the present disclosure.

FIG. 16 shows a schematic diagram of a vehicle according to embodiments of the present disclosure.

FIG. 17 is a block diagram of an electronic device 800 according to an exemplary embodiment.

### DETAILED DESCRIPTION

The various exemplary embodiments, features, and aspects of the present disclosure are described below in detail with reference to the accompanying drawings. The same signs in the accompanying drawings represent elements having the same or similar functions. Although the various aspects of the embodiments are illustrated in the accompanying drawings, unless stated particularly, it is not required to draw the accompanying drawings in proportion.

The special word “exemplary” here means “used as examples, embodiments, or descriptions”. Any “exemplary” embodiment given here is not necessarily construed as being superior to or better than other embodiments.

The term “and/or” as used herein merely describes an association relationship between associated objects, indicating that there may be three relationships, for example. A and/or B, which may indicate that A exists separately, both A and B exist, and B exists separately. In addition, the term “at least one” as used herein means any one of multiple elements or any combination of at least two of the multiple elements, for example, including at least one of A, B, or C, which indicates that any one or more elements selected from a set consisting of A, B, and C are included.

In addition, numerous details are given in the following detailed description for the purpose of better explaining the present disclosure. A person skilled in the art should understand that the present disclosure may also be implemented without some specific details. In some examples, methods, means, elements, and circuits well known to a person skilled in the art are not described in detail so as to highlight the subject matter of the present disclosure.

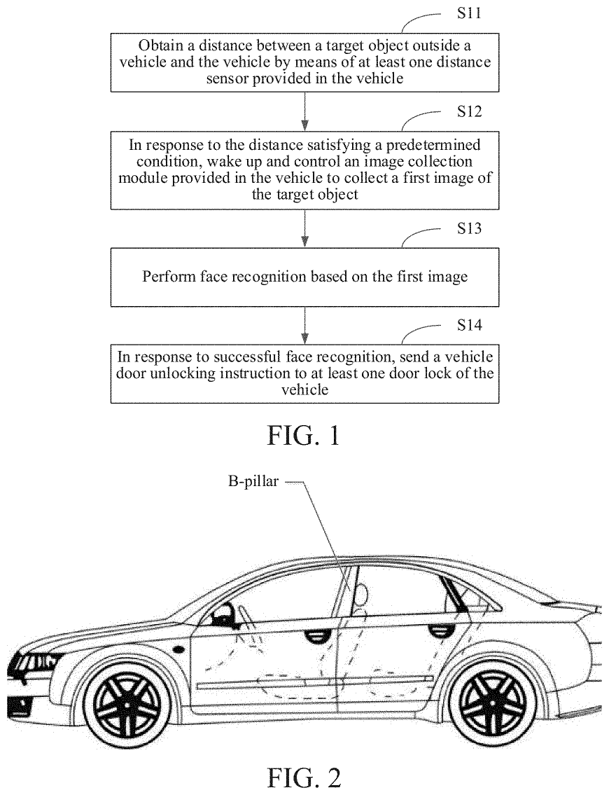

FIG. 1 shows a flowchart of a vehicle door unlocking method according to embodiments of the present disclosure. An executive body of the vehicle door unlocking method is a vehicle door unlocking apparatus. For example, the vehicle door unlocking apparatus is installed on at least one of the following positions: a B-pillar, at least one vehicle door, or at least one rearview mirror of the vehicle. FIG. 2 shows a schematic diagram of a B-pillar of a vehicle. For example, the vehicle door unlocking apparatus may be installed on the B-pillar from 130 cm to 160 cm above the ground. The horizontal recognition distance of the vehicle door unlocking apparatus is 30 cm to 100 cm, which is not limited here. FIG. 3 shows a schematic diagram of an installation height and a recognizable height range of the vehicle door unlocking apparatus in the vehicle door unlocking method according to embodiments of the present disclosure. In the example shown in FIG. 3, the installation height of the vehicle door unlocking apparatus is 160 cm, and the recognizable height range is 140 cm to 190 cm.

In one possible implementation, the vehicle door unlocking method may be implemented by a processor invoking a computer-readable instruction stored in a memory.

As shown in FIG. 1, the vehicle door unlocking method includes steps S11, to S14.

At step S11, a distance between a target object outside a vehicle and the vehicle is obtained by means of at least one distance sensor provided in the vehicle.

In one possible implementation, at least one distance sensor includes a Bluetooth distance sensor. Obtaining the distance between the target object outside the vehicle and the vehicle by means of the at least one distance sensor provided in the vehicle includes: establishing a Bluetooth pairing connection between an external device and the Bluetooth distance sensor; and in response to a successful Bluetooth pairing connection, obtaining a first distance between the target object with the external device and the vehicle by means of the Bluetooth distance sensor.

In this implementation, the external device may be any Bluetooth-enabled mobile device. For example, the external device may be a mobile phone, a wearable device, or an electronic key, etc. The wearable device may be a smart bracelet or smart glasses.

In one example, in the case that at least one distance sensor includes a Bluetooth distance sensor, a Received Signal Strength indication (RSSI) may be used to measure a first distance between a target object with an external device and a vehicle, where the distance range of Bluetooth ranging is 1 to 100 m. For example, Formula 1 is used to determine the first distance between the target object with the external device and the vehicle,

P=A-10n·lgr Formula 1,

where P represents the current RSSI, A represents the RSSI when the distance between a master machine and a slave machine (the Bluetooth distance sensor and the external device) is 1 m, n represents a propagation factor which is related to the environment such as temperature and humidity, and r represents the first distance between the target object with the external device and the Bluetooth sensor.

In one example, n changes as the environment changes. Before performing ranging in different environments, n is adjusted according to environmental factors such as temperature and humidity. The accuracy of Bluetooth ranging in different environments can be improved by adjusting n according to the environmental factors.

In one example, A is calibrated according to different external devices. The accuracy of Bluetooth ranging for different external devices can be improved by calibrating A according to different external devices.

In one example, first distances sensed by the Bluetooth distance sensor may be obtained multiple times, and whether the predetermined condition is satisfied is determined according to the average value of the first distances obtained multiple times, thereby reducing the error of single ranging.

In this implementation, by establishing a Bluetooth pairing connection between the external device and the Bluetooth distance sensor, a layer of authentication is added by means of Bluetooth, thereby improving the security of vehicle door unlocking.

In another possible implementation, at least one distance sensor includes: an ultrasonic distance sensor. Obtaining the distance between the target object outside the vehicle and the vehicle by means of the at least one distance sensor provided in the vehicle includes: obtaining a second distance between the target object and the vehicle by means of the ultrasonic distance sensor provided on an outside of the vehicle.

In one example, the measurement range of the ultrasonic ranging may be 0.1 to 10 m, and the measurement accuracy may be 1 cm. The formula for ultrasonic ranging may be expressed as Formula 3:

L=C×Tᵤ Formula 3,

where L represents the second distance, C represents the propagation speed of the ultrasonic wave in the air, and Tᵤ is equal to ½ of the time difference between the transmission time of the ultrasonic wave and the reception time.

At step S12, in response to the distance satisfying a predetermined condition, an image collection module provided in the vehicle is waked up and controlled to collect a first image of the target object.

In one possible implementation, the predetermined condition includes at least one of the following: the distance is less than a predetermined distance threshold; a duration in which the distance is less than the predetermined distance threshold reaches a predetermined time threshold; or the distance obtained in the duration indicates that the target object is proximate to the vehicle.

In one example, the predetermined condition is that the distance is less than a predetermined distance threshold. For example, if the average value of the first distances sensed by the Bluetooth distance sensor multiple times is less than the distance threshold, it is determined that the predetermined condition is satisfied. For example, the distance threshold is 5 m.

In another example, the predetermined condition is that the duration that a duration in which the distance is less than the predetermined distance threshold reaches a predetermined time threshold. For example, in the case of obtaining the second distance sensed by the ultrasonic distance sensor, if the duration in which the second distance is less than the distance threshold reaches the time threshold, it is determined that the predetermined condition is satisfied.

In one possible implementation, at least one distance sensor includes: a Bluetooth distance sensor and an ultrasonic distance sensor. Obtaining the distance between the target object outside the vehicle and the vehicle by means of the at least one distance sensor provided in the vehicle includes: establishing the Bluetooth pairing connection between the external device and the Bluetooth distance sensor; in response to a successful Bluetooth pairing connection, obtaining the first distance between the target object with the external device and the vehicle by means of the Bluetooth distance sensor; and obtaining the second distance between the target object and the vehicle by means of the ultrasonic distance sensor. In response to the distance satisfying the predetermined condition, waking up and controlling the image collection module provided in the vehicle to collect the first image of the target object includes: in response to the first distance and the second distance satisfying the predetermined condition, waking up and controlling the image collection module provided in the vehicle to collect the first image of the target object.

In this implementation, the security of vehicle door unlocking is improved by means of the cooperation of the Bluetooth distance sensor and the ultrasonic distance sensor.

In one possible implementation, the predetermined condition includes a first predetermined condition and a second predetermined condition. The first predetermined condition includes at least one of the following: the first distance is less than a predetermined first distance threshold; the duration in which the first distance is less than the predetermined first distance threshold reaches the predetermined time threshold; or the first distance obtained in the duration indicates that the target object is proximate to the vehicle. The second predetermined condition includes: the second distance is less than a predetermined second distance threshold; the duration in which the second distance is less than the predetermined second distance threshold reaches the predetermined time threshold; and the second distance threshold is less than the first distance threshold.

In one possible implementation, in response to the first distance and the second distance satisfying the predetermined condition, waking up and controlling the image collection module provided in the vehicle to collect the first image of the target object includes: in response to the first distance satisfying the first predetermined condition, waking up a face recognition system provided in the vehicle; and in response to the second distance satisfying the second predetermined condition, controlling the image collection module to collect the first image of the target object by means of a waked-up face recognition system.

The wake-up process of the face recognition system generally takes some time, for example, it takes 4 to 5 seconds, which makes the trigger and processing of face recognition slower, affecting the user experience. In the foregoing implementation, by combining the Bluetooth distance sensor and the ultrasonic distance sensor, when the first distance obtained by the Bluetooth distance sensor satisfies the first predetermined condition, the face recognition system is waked up so that the face recognition system is in a working state in advance. When the second distance obtained by the ultrasonic distance sensor satisfies the second predetermined condition, the face image processing is performed quickly by means of the face recognition system, thereby increasing the face recognition efficiency and improving the user experience.

In one possible implementation, the distance sensor is an ultrasonic distance sensor. The predetermined distance threshold is determined according to a calculated distance threshold reference value and a predetermined distance threshold offset value. The distance threshold reference value represents a reference value of a distance threshold between an object outside the vehicle and the vehicle. The distance threshold offset value represents an offset value of the distance threshold between the object outside the vehicle and the vehicle.

In one example, the distance offset value is determined based on the distance occupied by a person while standing. For example, the distance offset value is set to a default value during initialization. For example, the default value is 10 cm.

In one possible implementation, the predetermined distance threshold is equal to a difference between the distance threshold reference value and the predetermined distance threshold offset value. For example, if the distance threshold reference value is D′ and the distance threshold offset value is D_{w}, the predetermined distance threshold is determined by using Formula 4.

D=D′−D_{w} Formula 4.

It should be noted that although by taking the predetermined distance threshold equal to the difference between the distance threshold reference value and the distance threshold offset value as an example, the manner in which the predetermined distance threshold is determined according to the distance threshold reference value and the distance threshold offset value is described above, a person skilled in the art could understand that the present disclosure should not be limited thereto. A person skilled in the art may flexibly set, according to actual application scenario requirements and/or personal preferences, a specific implementation manner in which the predetermined distance threshold is determined according to the distance threshold reference value and the distance threshold offset value. For example, the predetermined distance threshold may be equal to the sum of the distance threshold reference value and the distance threshold offset value. For another example, a product of the distance threshold offset value and a fifth preset coefficient may be determined, and a difference between the distance threshold reference value and the product may be determined as a predetermined distance threshold.

In one example, the distance threshold reference value is a minimum value of an average distance value after the vehicle is turned off and a maximum vehicle door unlocking distance, where the average distance value after the vehicle is turned off represents an average value of distances between the object outside the vehicle and the vehicle within a specified time period after the vehicle is turned off. For example, if the specified time period after the vehicle is turned off is N seconds after the vehicle is turned off, the average value of the distances sensed by the distance sensor during the specified time period after the vehicle is turned off is:

$${\sum }_{t = 1}^{N} \frac{D ( t )}{N} ,$$

where D(t) represents the distance value at time t obtained from the distance sensor. For example, the maximum distance for vehicle door unlocking is Dₐ, and the distance threshold reference value is determined using Formula 5.

$${D}^{′} = min ( {\sum }_{t = 1}^{N} \frac{D ( t )}{N} , {D}_{a} ) . \qquad Formula 5$$

That is, the distance threshold reference value is the minimum value of the average distance value

$${\sum }_{t = 1}^{N} \frac{D ( t )}{N}$$

after the vehicle is turned off and the maximum distance Dₐ for vehicle door unlocking.

In another example, the distance threshold reference value is equal to the average distance value after the vehicle is turned off. In this example, the distance threshold reference value may be determined only by means of the average distance value after the vehicle is turned off, regardless of the maximum distance for vehicle door unlocking.

In another example, the distance threshold reference value is equal to the maximum distance for vehicle door unlocking. In this example, the distance threshold reference value may be determined only by means of the maximum distance for vehicle door unlocking, regardless of the average distance value after the vehicle is turned off.

In one possible implementation, the distance threshold reference value is periodically updated. For example, the update period of the distance threshold reference value is 5 minutes, that is, the distance threshold reference value is updated every 5 minutes. By periodically updating the distance threshold reference value, different environments are adapted.

In another possible implementation, after the distance threshold reference value is determined, the distance threshold reference value is not updated.

In another possible implementation, the predetermined distance threshold is set to a default value.

In one possible implementation, the distance sensor is an ultrasonic distance sensor. The predetermined time threshold is determined according to a calculated time threshold reference value and a time threshold offset value, where the time threshold reference value represents a reference value of a time threshold at which a distance between the object outside the vehicle and the vehicle is less than the predetermined distance threshold, and the time threshold offset value represents an offset value of the time threshold at which the distance between the object outside the vehicle and the vehicle is less than the predetermined distance threshold.

In some embodiments, the time threshold offset value is determined experimentally. in one example, the time threshold offset value may default to ½ of the time threshold reference value. It should be noted that a person skilled in the art may flexibly set the time threshold offset value according to the actual application scenario requirements and/or personal preferences, which is not limited herein.

In another possible implementation, the predetermined time threshold is set to a default value.

In one possible implementation, the predetermined time threshold is equal to the sum of the time threshold reference value and the time threshold offset value. For example, if the time threshold reference value is Tₛ and the time threshold offset value is T_{w}, the predetermined time threshold is determined by using Formula 6.

T=Tₛ+T_{w} Formula 6.

It should be noted that although by taking the predetermined time threshold equal to the sum of the time threshold reference value and the tune threshold offset value as an example, the manner in which the predetermined time threshold is determined according to the time threshold reference value and the time threshold offset value is described above, a person skilled in the art could understand that the present disclosure should not be limited thereto. A person skilled in the art may flexibly set, according to actual application scenario requirements and/or personal preferences, a specific implementation manner in which the predetermined time threshold is determined according to the time threshold reference value and the time threshold offset value. For example, the predetermined time threshold may be equal to the sum of the time threshold reference value and the time threshold offset value. For another example, a product of the time threshold offset value and a sixth preset coefficient may be determined, and the sum of the time threshold reference value and the product may be determined as a predetermined time threshold.

In one possible implementation, the time threshold reference value is determined according to one or more of a horizontal detection angle of the ultrasonic distance sensor, a detection radius of the ultrasonic distance sensor, an object size, and an object speed.

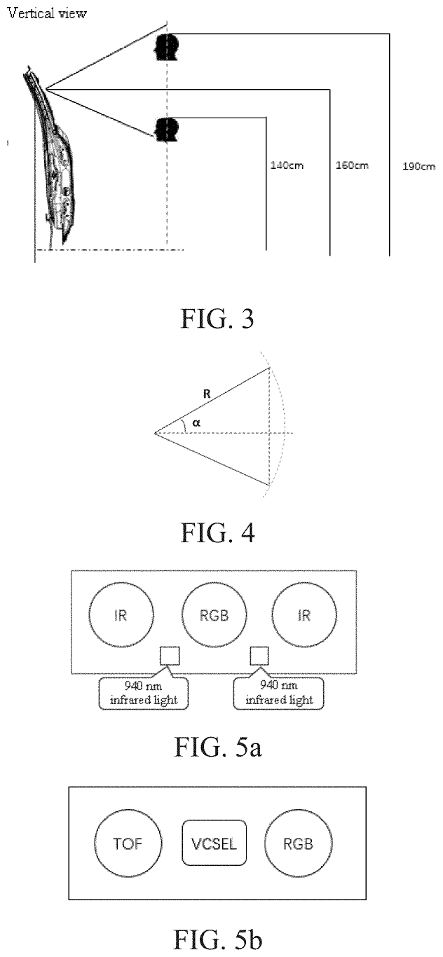

FIG. 4 shows a schematic diagram of a horizontal detection angle of an ultrasonic distance sensor and a detection radius of the ultrasonic distance sensor in the vehicle door unlocking method according to embodiments of the present disclosure. For example, the time threshold reference value is determined according to the horizontal detection angle of the ultrasonic distance sensor, the detection radius of the ultrasonic distance sensor, at least one type of object sizes, and at least one type of object speeds. The detection radius of the ultrasonic distance sensor may be the horizontal detection radius of the ultrasonic distance sensor. The detection radius of the ultrasonic distance sensor may be equal to the maximum distance for vehicle door unlocking, for example, it may be equal to 1 m.

In other examples, the time threshold reference value may be set to a default value, or the time threshold reference value may be determined according to other parameters, which is not limited herein.

In one possible implementation, the method further includes: determining alternative reference values corresponding to different types of objects according to different types of object sizes, different types of object speeds, the horizontal detection angle of the ultrasonic distance sensor, and the detection radius of the ultrasonic distance sensor; and determining the time threshold reference value from the alternative reference values corresponding to the different types of objects.

For example, the type includes pedestrian type, bicycle type, and motorcycle type, etc. The object size may be the width of the object. For example, the object size of the pedestrian type may be an empirical value of the width of a pedestrian, and the object size of the bicycle type may be an empirical value of the width of a bicycle. The object speed may be an empirical value of the speed of an object. For example, the object speed of the pedestrian type may be an empirical value of the walking speed of the pedestrian.

In one example, determining alternative reference values corresponding to different types of objects according to different types of object sizes, different types of object speeds, the horizontal detection angle of the ultrasonic distance sensor, and the detection radius of the ultrasonic distance sensor includes: determining an alternative reference value T₁ corresponding to an object of type i by using Formula 2,

$${T}_{i} = \frac{2 sin α \times R + {d}_{i}}{{v}_{i}} , \qquad Formula 2$$

where α represents the horizontal detection angle of the distance sensor, R represents the detection radius of the distance sensor, dᵢ represents the size of the object of type i, and vᵢ represents the speed of the object of type i.

It should be noted that although by taking Formula 2 as an example, the manner in which alternative reference values corresponding to different types of objects are determined according to different types of object sizes, different types of object speeds, the horizontal detection angle of the ultrasonic distance sensor, and the detection radius of the ultrasonic distance sensor is as described above, a person skilled in the art could understand that the present disclosure should not be limited thereto. For example, a person skilled in the art may adjust Formula 2 to satisfy the actual application scenario requirements.

In one possible implementation, determining the time threshold reference value from the alternative reference values corresponding to the different types of objects includes: determining a maximum value among the alternative reference values corresponding to the different types of objects as the time threshold reference value.

In other examples, the average value of the alternative reference values corresponding to different types of objects may be determined as the time threshold reference value, or one of the alternative reference values corresponding to different types of objects may be randomly selected as the time threshold reference value, which is not limited here.

In some embodiments, in order not to affect the experience, the predetermined time threshold is set to less than 1 second. In one example, the interference caused by pedestrians, bicycles, etc. is reduced by reducing the horizontal detection angle of the ultrasonic distance sensor.

In the embodiments of the present disclosure, the predetermined time threshold may not be dynamically updated according to the environment.

In the embodiments of the present disclosure, the distance sensor may keep running with low power consumption (<5 mA) for a long time.

At step S13, face recognition is performed based on the first image.

In one possible implementation, the face recognition includes: spoofing detection and face authentication. Performing the face recognition based on the first image includes: collecting, by an image sensor in the image collection module, the first image, and performing the face authentication based on the first image and a pre-registered face feature; and collecting, by a depth sensor in the image collection module, a first depth map corresponding to the first image, and performing the spoofing detection based on the first image and the first depth map.

In the embodiments of the present disclosure, the first image includes a target object. The target object may be a face or at least a part of a human body, which is not limited in the embodiments of the present disclosure.

The first image may be a still image or a video frame image. For example, the first image may be an image selected from a video sequence, where the image may be selected from the video sequence in multiple ways. In one specific example, the first image is an image selected from a video sequence that satisfies a preset quality condition, and the preset quality condition includes one or any combination of the following: whether the target object is included, whether the target object is located in the central region of the image, whether the target object is completely contained in the image, the proportion of the target object in the image, the state of the target object (such as the face angle), image resolution, and image exposure, etc., which is not limited in the embodiments of the present disclosure.

In one example, spoofing detection is first performed, and then face authentication is performed. For example, if the spoofing detection result of the target object is that the target object is non-spoofing, the face authentication process is triggered. If the spoofing detection result of the target object is that the target object is spoofing, the face authentication process is not triggered.

In another example, face authentication is first performed, and then spoofing detection is performed. For example, if the face authentication is successful, the spoofing detection process is triggered. If the face authentication fails, the spoofing detection process is not triggered.

In another example, spoofing detection and face authentication are performed simultaneously.

In this implementation, the spoofing detection is used to verify whether the target object is a human body, for example, it may be used to verify whether the target object is a human body. Face authentication is used to extract a face feature in the collected image, compare the face feature in the collected image with a pre-registered face feature, and determine whether the face features belong to the same person. For example, it may be determined whether the face feature in the collected image belongs to the face feature of the vehicle owner.

In the embodiments of the present disclosure, the depth sensor refers to a sensor for collecting depth information. The embodiments of the present disclosure do not limit the working principle and working band of the depth sensor.

In the embodiments of the present disclosure, the image sensor and the depth sensor of the image collection module may be set separately or together. For example, the image sensor and the depth sensor of the image collection module may be set separately: the image sensor uses a Red, Green, Blue (RGB) sensor or an infrared (IR) sensor, and the depth sensor uses a binocular IR sensors or a Time of Flight (TOF) sensor. The image sensor and the depth sensor of the image collection module and the depth sensor may be set together: the image collection module uses a Red, Green, Blue, Deep (RGBD) sensor to implement the functions of the image sensor and the depth sensor.

As one example, the image sensor is an RGB sensor. If the image sensor is an RGB sensor, the image collected by the image sensor is an RGB image.

As another example, the image sensor is an IR sensor. If the image sensor is an IR sensor, the image collected by the image sensor is an IR image. The IR image may be an IR image with a light spot or an IR image without a light spot.

In other examples, the image sensor may be another type of sensor, which is not limited in the embodiments of the present disclosure.

Optionally, the vehicle door unlocking apparatus may obtain the first image in multiple ways. For example, in some embodiments, a camera is provided on the vehicle door unlocking apparatus, and the vehicle door unlocking apparatus collects a still image or a video stream by means of the camera to obtain a first image, which is not limited in the embodiments of the present disclosure

As one example, the depth sensor is a three-dimensional sensor. For example, the depth sensor is a binocular IR sensor, a TOF sensor, or a structured light sensor, where the binocular IR sensor includes two IR cameras. The structured light sensor may be a coded structured light sensor or a speckle structured light sensor. The depth map of the target object is obtained by means of the depth sensor, and a high-precision depth map is obtained. The embodiments of the present disclosure use the depth map containing the target object for spoofing detection, which may fully mine the depth information of the target object, thereby improving the accuracy of the spoofing detection. For example, when the target object is a face, the embodiments of the present disclosure use the depth map containing the face to perform the spoofing detection, which may fully mine the depth information of the face data, thereby improving the accuracy of the spoofing face detection.

In one example, the TOF sensor uses a TOF module based on the IR band. In this example, by using the TOF module based on the IR band, the influence of external light on the depth map photographing may be reduced.

In the embodiments of the present disclosure, the first depth map corresponds to the first image. For example, the first depth map and the first image are respectively obtained by the depth sensor and the image sensor for the same scenario, or the first depth map and the first image are obtained by the depth sensor and the image sensor for the same target region at the same moment, which is not limited in the embodiments of the present disclosure.

FIG. 5a shows a schematic diagram of an image sensor and a depth sensor in the vehicle door unlocking method according to embodiments of the present disclosure. In the example shown in FIG. 5a, the image sensor is an RGB sensor, the camera of the image sensor is an RGB camera, the depth sensor is a binocular IR sensor, the depth sensor includes two IR cameras, and the two IR cameras of the binocular IR sensor are located on both sides of the RGB camera of the image sensor. The two IR cameras collect depth information based on the binocular disparity principle.

In one example, the image collection module further includes at least one fill light. The at least one fill light is provided between the IR camera of the binocular IR sensor and the camera of the image sensor. The at least one fill light includes at least one of a fill light for the image sensor or a fill light for the depth sensor. For example, if the image sensor is an RGB sensor, the fill light for the image sensor may be a white light. If the image sensor is an IR sensor, the fill light for the image sensor may be an IR light. If the depth sensor is binocular IR sensor, the fill light for the depth sensor may be an IR light. In the example shown in FIG. 5a, the IR light is provided between the IR camera of the binocular IR sensor and the camera of the image sensor. For example, the IR light uses IR ray at 940 nm.

In one example, the fill light may be in a normally-on mode. In this example, when the camera of the image collection module is in the working state, the fill light is in a turn-on state.

In another example, the fill light may be turned on when there is insufficient light. For example, the ambient light intensity is obtained by means of an ambient light sensor, and when the ambient light intensity is lower than a light intensity threshold, it is determined that the light is insufficient, and the fill light is turned on.

FIG. 5b shows another schematic diagram of an image sensor and a depth sensor in the vehicle door unlocking method according to embodiments of the present disclosure. In the example shown in FIG. 5b, the image sensor is an RGB sensor, the camera of the image sensor is an RGB camera, and the depth sensor is a TOF sensor,

In one example, the image collection module further includes a laser provided between the camera of the depth sensor and the camera of the image sensor. For example, the laser is provided between the camera of the TOF sensor and the camera of the RGB sensor. For example, the laser may be a Vertical Cavity Surface Emitting Laser (VCSEL), and the TOF sensor may collect a depth map based on the laser emitted by the VCSEL.

In the embodiments of the present disclosure, the depth sensor is used to collect the depth map, and the image sensor is used to collect a two-dimensional image. It should be noted that although the image sensor is described by taking the RGB sensor and the IR sensor as an example, and the depth sensor is described by taking the binocular IR sensor, the TOF sensor, and the structured light sensor as an example, a person skilled in the art could understand that the embodiments of the present disclosure should not be limited thereto. A person skilled in the art selects the types of the image sensor and the depth sensor according to the actual application requirements, as long as the collection of the two-dimensional image and the depth map is implemented, respectively.

At step S14, in response to successful face recognition, a vehicle door unlocking instruction is sent to at least one vehicle door lock of the vehicle.

In one example, the SoC of the vehicle door unlocking apparatus may send a vehicle door unlocking instruction to the vehicle door domain controller to control the door to be unlocked.

The vehicle door in the embodiments of the present disclosure includes a vehicle door (for example, a left front door, a right front door, a left rear door, and a right rear door) through which the person enters and exits, or a trunk door of the vehicle. Accordingly, the at least one vehicle door lock includes at least one of a left front door lock, a right front door lock, a left rear door lock, a right rear door lock, or a trunk door lock, etc.

In one possible implementation, the face recognition further includes permission authentication. Performing the face recognition based on the first image includes: obtaining door-opening permission information of the target object based on the first image; and performing permission authentication based on the door-opening permission information of the target object. According to this implementation, different pieces of door-opening permission information are set for different users, thereby improving the safety of the vehicle.

As one example of this implementation, the door-opening permission information of the target object includes one or more of the following: information about a door where the target object has door-opening permission, the time when the target object has door-opening permission, and the number of door-opening permissions corresponding to the target object.

For example, the information about a door where the target object has door-opening permission may be all or part of the doors. For example, the door that the vehicle owner or the family members or friends thereof have the door-opening permission may he all doors, and the door that the courier or the property staff has the door-opening permission may be the trunk door. The vehicle owner may set the information about the door that has the door-opening permission for other personnel. For another example, in the scenario of online ride-hailing, the door that the passenger has the door-opening permission may be a non-cab door and the trunk door.

For example, the time when the target object has the door-opening permission may be all time, or may be a preset time period. For example, the time when the vehicle owner or the family members thereof have the door-opening permission may be all time. The vehicle owner may set the time when other personnel has the door-opening permission. For example, in an application scenario where a friend of the vehicle owner borrows the vehicle from the vehicle owner, the vehicle owner may set the door opening time for the friend as two days. For another example, after the courier contacts the vehicle owner, the vehicle owner may set the door opening time for the courier to be 13:00-14:00 on Sep. 29, 2019. For another example, in a vehicle rental scenario, if a customer rents the vehicle for 3 days, the staff of a vehicle rental agency may set the door opening time for the customer as 3 days. For another example, in the scenario of online ride-hailing, the time when the passenger has the door-opening permission may be the service period of the travel order.

For example, the number of door-opening permissions corresponding to the target object may be unlimited or limited. For example, the number of door-opening permissions corresponding to the vehicle owner or family members or friends thereof may be unlimited. For another example, the number of door-opening permissions corresponding to the courier may be a limited number, such as 1.

In one possible implementation, performing the spoofing detection based on the first image and the first depth map includes: updating the first depth map based on the first image to obtain a second depth map; and determining a spoofing detection result of the target object based on the first image and the second depth map.

Specifically, depth values of one or more pixels in the first depth map are updated based on the first image to obtain the second depth map.

In some embodiments, a depth value of a depth invalidation pixel in the first depth map is updated based on the first image to obtain the second depth map.

The depth invalidation pixel in the depth map refers to a pixel with an invalid depth value included in the depth map, i.e., a pixel with inaccurate depth value or apparently inconsistent with actual conditions. The number of depth invalidation pixels may be one or more. By updating the depth value of at least one depth invalidation pixel in the depth map, the depth value of the depth invalidation pixel is more accurate, which helps to improve the accuracy of the spoofing detection.

In some embodiments, the first depth map is a depth map with a missing value. The second depth map is obtained by repairing the first depth map based on the first image. Optionally, repairing the first depth map includes determining or supplementing the depth value of the pixel of the missing value. However, the embodiments of the present disclosure are not limited thereto.

In the embodiments of the present disclosure, the first depth map may be updated or repaired in multiple ways. In some embodiments, the first image is directly used for performing spoofing detection. For example, the first depth map is directly updated using the first image. In other embodiments, the first image is pre-processed, and spoofing detection is performed based on the pre-processed first image. For example, an image of the target object is obtained from the first image, and the first depth map is updated based on the image of the target object.

The image of the target object can be captured from the first image in multiple ways. As one example, target detection is performed on the first image to obtain position information of the target object, for example, position information of a bounding box of the target object, and an image of the target object is captured from the first image based on the position information of the target object. For example, an image of a region where the bounding box of the target object is located is captured from the first image as the image of the target object. For another example, the bounding box of the target object is enlarged by a certain factor and an image of a region where the enlarged bounding box is located is captured from the first image as the image of the target object. As another example, key point information of the target object in the first image is obtained, and an image of the target object is obtained from the first image based on the key point information of the target object.

Optionally, target detection is performed on the first image to obtain position information of a region where the target object is located. Key point detection is performed on an image of the region where the target object is located to obtain key point information of the target object in the first image.

Optionally, the key point information of the target object includes position information of a plurality of key points of the target object. If the target object is a face, the key point of the target object includes one or more of an eye key point, an eyebrow key point, a nose key point, a mouth key point, and a face contour key point, etc. The eye key point includes one or more of an eye contour key point, an eye corner key point, and a pupil key point, etc.

In one example, a contour of the target object is determined based on the key point information of the target object, and an image of the target object is captured from the first image according to the contour of the target object. Compared with the position information of the target object obtained by means of target detection, the position of the target object obtained by means of the key point information is more accurate, which is beneficial to improve the accuracy of subsequent spoofing detection.

Optionally, the contour of the target object in the first image is determined based on the key point of the target object in the first image, and the image of the region where the contour of the target object in the first image is located or the image of the region obtained after being enlarged by a certain factor is determined as the image of the target object. For example, an elliptical region determined based on the key point of the target object in the first image may be determined as the image of the target object, or the smallest bounding rectangular region of the elliptical region determined based on the key point of the target object in the first image is determined as the image of the target object, which is not limited in the embodiments of the present disclosure.

In this way, by obtaining the image of the target object from the first image and performing the spoofing detection based on the image of the target object, it is possible to reduce the interference of the background information in the first image on the spoofing detection.

In the embodiments of the present disclosure, update processing may be performed on the obtained original depth map. Alternatively, in some embodiments, the depth map of the target object is obtained from the first depth map, and the depth map of the target object is updated based on the first image to obtain the second depth map.

As one example, position information of the target object in the first image is obtained, and the depth map of the target object is obtained from the first depth map based on the position information of the target object. Optionally, registration or alignment processing is performed on the first depth map and the first image in advance, which is not limited in the embodiments of the present disclosure.

In this way, the depth map of the target object is obtained from the first depth map, and the depth map of the target object is updated based on the first image to obtain a second depth map, thereby reducing interference of the background information in the first depth map on the spoofing detection.

In some embodiments, after the first image and the first depth map corresponding to the first image are obtained, the first image and the first depth map are aligned according to parameters of the image sensor and parameters of the depth sensor.

As one example, conversion processing may be performed on the first depth map so that the first depth map subjected to the conversion processing and the first image are aligned. For example, a first transformation matrix may be determined according to the parameters of the depth sensor and the parameters of the image sensor, and conversion processing is performed on the first depth map according to the first transformation matrix. Accordingly, at least a part of the first depth map subjected to the conversion processing may be updated based on at least a part of the first image to obtain the second depth map. For example, the first depth map subjected to the conversion processing is updated based on the first image to obtain the second depth map. For another example, the depth map of the target object captured from the first depth map is updated based on the image of the target object captured from the first image to obtain the second depth map, and so on.

As another example, conversion processing is performed on the first image, so that the first image subjected to the conversion processing is aligned with the first depth map. For example, a second transformation matrix may be determined according to the parameters of the depth sensor and the parameters of the image sensor, and conversion processing is performed on the first image according to the second transformation matrix. Accordingly, at least a part of the first depth map may be updated based on at least a part of the first image subjected to the conversion processing to obtain the second depth map.

Optionally, the parameters of the depth sensor includes intrinsic parameters and/or extrinsic parameters of the depth sensor, and the parameters of the image sensor includes intrinsic parameters and/or extrinsic parameters of the image sensor. By aligning the first depth map with the first image, the positions of the corresponding parts of the first depth map and the first image can he made the same in the two images.

In the above example, the first image is an original image (such as an RGB or IR image), and in other embodiments, the first image may also refer to an image of the target object captured from the original image. Similarly, the first depth map may also refer to a depth map of the target object captured from an original depth map, which is not limited in the embodiments of the present disclosure.

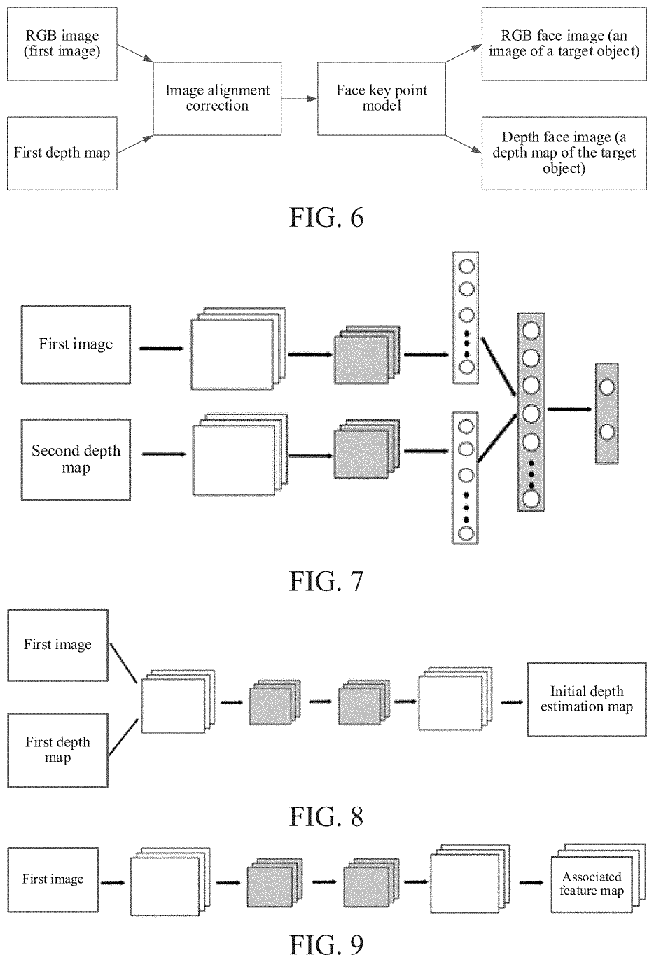

FIG. 6 shows a schematic diagram of one example of a spoofing detection method according to embodiments of the present disclosure. In the example shown in FIG. 6, the first image is an RGB image and the target object is a face. Alignment correction processing is performed on the RGB image and the first depth map, and the processed image is input to a face key point model for processing, to obtain an RGB face image (an image of the target object) and a depth face image (a depth image of the target object), and the depth face image is updated or repaired based on the RGB face image. In this way, the subsequent data processing capacity is reduced, and the efficiency and accuracy of spoofing detection is improved.

In the embodiments of the present disclosure, the spoofing detection result of the target object is that the target object is non-spoofing or the target object is spoofing.

In some embodiments, the first image and the second depth map are input to a spoofing detection neural network for processing to obtain a spoofing detection result of the target object. Alternatively, the first image and the second depth map are processed by means of other spoofing detection algorithm to obtain the spoofing detection result.

In some embodiments, feature extraction processing is performed on the first image to obtain first feature information. Feature extraction processing is performed on the second depth map to obtain second feature information. The spoofing detection result of the target object in the first image is determined based on the first feature information and the second feature information.

Optionally, the feature extraction processing may be implemented by means of a neural network or other machine learning algorithms, and the type of the extracted feature information may optionally be obtained by learning a sample, which is not limited in the embodiments of the present disclosure.

In some specific scenarios (such as a scenario with strong light outside), the obtained depth map (such as the depth map collected by the depth sensor) may fail in some areas. In addition, under normal lighting, partial invalidation of the depth map may also be randomly caused by factors such as reflection of the glasses, black hair, or frames of black glasses. Moreover, some special paper may make the printed face photos have a similar effect of large area invalidation or partial invalidation of the depth map. In addition, by blocking an active light source of the depth sensor, the depth map may also partially fails, and the imaging of a spoofing object in the image sensor is normal. Therefore, in the case that some or all of the depth maps fail, the use of depth maps to distinguish between a non-spoofing object and the spoofing object causes errors. Therefore, in the embodiments of the present disclosure, by repairing or updating the first depth map, and using the repaired or updated depth map to perform spoofing detection, it is beneficial to improve the accuracy of the spoofing detection,

FIG. 7 shows a schematic diagram of one example of determining a spoofing detection result of a target object in a first image based on the first image and a second depth map in the spoofing detection method according to embodiments of the present disclosure.

In this example, the first image and the second depth map are input to a spoofing detection network to perform spoofing detection processing to obtain a spoofing detection result.

As shown in FIG. 7, the spoofing detection network includes two branches, i.e., a first sub-network and a second sub-network, where the first sub-network is configured to perform feature extraction processing on the first image to obtain first feature information, and the second sub-network is configured to perform feature extraction processing on the second depth map to obtain second feature information.

In an optional example, the first sub-network includes a convolutional layer, a down-sampling layer, and a fully connected layer.

For example, the first sub-network includes one stage of convolutional layers, one stage of down-sampling layers, and one stage of fully connected layers. The stage of convolutional layers includes one or more convolutional layers. The stage of down-sampling layers includes one or more down-sampling layers. The stage of fully connected layers includes one or more fully connected layers.

For another example, the first sub-network includes multiple stages of convolutional layers, multi stages of down-sampling layers, and one stage of fully connected layers. Each stage of convolutional layers includes one or more convolutional layers. Each stage of down-sampling layers includes one or more down-sampling layers. The stage of fully connected layers includes one or more fully connected layers. The i-th stage of down-sampling layers is cascaded behind the i-th stage of convolutional layers, the (i+1)-th stage of convolutional layers is cascaded behind the i-th stage of down-sampling layers, and the fully connected layer is cascaded behind the n-th stage of down-sampling layers, where i and n are positive integers, 1≤i≤n, and n represents the number of convolutional layers and down-sampling layers in the depth prediction neural network.

Alternatively, the first sub-network includes a convolutional layer, a down-sampling layer, a normalization layer, and a fully connected layer.

For example, the first sub-network includes one stage of convolutional layers, a normalization layer, one stage of down-sampling layers, and one stage of fully connected layers. The stage of convolutional layers includes one or more convolutional layers. The stage of down-sampling layers includes one or more down-sampling layers. The stage of fully connected layers includes one or more fully connected layers.

For another example, the first sub-network includes multiple stages of convolutional layers, a plurality of normalization layers, multiple stages of down-sampling layers, and one stage of fully connected layers. Each stage of convolutional layers includes one or more convolutional layers. Each stage of down-sampling layers includes one or more down-sampling layers. The stage of fully connected layers includes one or more fully connected layers. The i-th stage of normalization layers is cascaded behind the i-th state of convolutional layers, the i-th stage of down-sampling layers is cascaded behind the i-th stage of normalization layers, the (i+1)-th stage of convolutional layers is cascaded behind the i-th stage of down-sampling layers, and the fully connected layer is cascaded behind the n-th stage of down-sampling layers, where i and n are positive integers, 1≤i≤n, and n represents the number of convolutional layers, the number of stages of the down-sampling layers, and the number of normalization layers in the first sub-network.

As one example, convolutional processing is performed on the first image to obtain a first convolutional result. Down-sampling processing is performed on the first convolutional result to obtain a first down-sampling result. The first feature information is obtained based on the first down-sampling result.

For example, convolutional processing and down-sampling processing are performed on the first image by means of the stage of convolutional layers and the stage of down-sampling layers. The stage of convolutional layers includes one or more convolutional layers. The stage of down-sampling layers includes one or more down-sampling layers.

For another example, convolutional processing and down-sampling processing are performed on the first image by means of the multiple stages of convolutional layers and the multiple stages of down-sampling layers. Each stage of convolutional layers includes one or more convolutional layers, and each stage of down-sampling layers includes one or more down-sampling layers.

For example, performing down-sampling processing on the first convolutional result to obtain the first down-sampling result includes: performing normalization processing on the first convolutional result to obtain a first normalization result; and performing down-sampling processing on the first normalization result to obtain the first down-sampling result.

For example, the first down-sampling result is input to the fully connected layer, and fusion processing is performed on the first down-sampling result by means of the fully connected layer to obtain first feature information.

Optionally, the second sub-network and the first sub-network have the same network structure, but have different parameters. Alternatively, the second sub-network has a different network structure from the first sub-network, which is not limited in the embodiments of the present disclosure.

As shown in FIG. 7, the spoofing detection network further includes a third sub-network configured to process the first feature information obtained from the first sub-network and the second feature information obtained from the second sub-network to obtain a spoofing detection result of the target object in the first image. Optionally, the third sub-network includes a fully connected layer and an output layer. For example, the output layer uses a softmax function. If an output of the output layer is 1, it is indicated that the target object is non-spoofing, and if the output of the output layer is 0, it is indicated that the target object is spoofing. However, the embodiments of the present disclosure do not limit the specific implementation of the third sub-network.

As one example, fusion processing is performed on the first feature information and the second feature information to obtain third feature information. A spoofing detection result of the target object in the first image is determined based on the third feature information.

For example, fusion processing is performed on the first feature information and the second feature information by means of the fully connected layer to obtain third feature information.

In some embodiments, a probability that the target object in the first image is non-spoofing is obtained based on the third feature information, and a spoofing detection result of the target object is determined according to the probability that the target object is non-spoofing.

For example, if the probability that the target object is non-spoofing is greater than a second threshold, it is determined that the spoofing detection result of the target object is that the target object is non-spoofing. For another example, if the probability that the target object is non-spoofing is less than or equal to the second threshold, it is determined that the spoofing detection result of the target object is spoofing.

In other embodiments, the probability that the target object is spoofing is obtained based on the third feature information, and the spoofing detection result of the target object is determined according to the probability that the target object is spoofing. For example, if the probability that the target object is spoofing is greater than a third threshold, it is determined that the spoofing detection result of the target object is that the target object is spoofing. For another example, if the probability that the target object is spoofing is less than or equal to the third threshold, it is determined that the spoofing detection result of the target object is non-spoofing.

In one example, the third feature information is input into the Softmax layer, and the probability that the target object is non-spoofing or spoofing is obtained by means of the Softmax layer. For example, an output of the Softmax layer includes two neurons, where one neuron represents the probability that the target object is non-spoofing and the other neuron represents the probability that the target object is spoofing. However, the embodiments of the disclosure are not limited thereto.

In the embodiments of the present disclosure, a first image and a first depth map corresponding to the first image are obtained, the first depth map is updated based on the first image to obtain a second depth map, and a spoofing detection result of the target object in the first image is determined based on the first image and the second depth map, so that the depth maps are improved, thereby improving the accuracy of the spoofing detection.

In one possible implementation, updating the first depth map based on the first image to obtain the second depth map includes: determining depth prediction values and associated information of a plurality of pixels in the first image based on the first image, where the associated information of the plurality of pixels indicates a degree of association between the plurality of pixels; and updating the first depth map based on the depth prediction values and associated information of the plurality of pixels to obtain the second depth map.

Specifically, the depth prediction values of the plurality of pixels in the first image are determined based on the first image, and repairing and improvement are performed on the first depth map based on the depth prediction values of the plurality of pixels,

Specifically, depth prediction values of a plurality of pixels in the first image are obtained by processing the first image. For example, the first image is input to a depth prediction depth network for processing to obtain depth prediction results of the plurality of pixels, for example, a depth prediction map corresponding to the first image is obtained, which is not limited in the embodiments of the present disclosure.

In some embodiments, the depth prediction values of the plurality of pixels in the first image are determined based on the first image and the first depth map.

As one example, the first image and the first depth map are input to a depth prediction neural network for processing to obtain the depth prediction values of the plurality of pixels in the first image. Alternatively, the first image and the first depth map are processed in other manners to obtain depth prediction values of the plurality of pixels, which is not limited in the embodiments of the present disclosure.

FIG. 8 shows a schematic diagram of a depth prediction neural network in the vehicle door unlocking method according to embodiments of the present disclosure. As shown in FIG. 8, the first image and the first depth map are input to the depth prediction neural network for processing, to obtain an initial depth estimation map. Depth prediction values of the plurality of pixels in the first image are determined based on the initial depth estimation map. For example, a pixel value of the initial depth estimation map is the depth prediction value of a corresponding pixel in the first image.

The depth prediction neural network is implemented by means of multiple network structures. In one example, the depth prediction neural network includes an encoding portion and a decoding portion. Optionally, the encoding portion includes a convolutional layer and a down-sampling layer, and the decoding portion includes a deconvolution layer and/or an up-sampling layer. In addition, the encoding portion and/or the decoding portion further includes a normalization layer, and the specific implementation of the encoding portion and the decoding portion is not limited in the embodiments of the present disclosure. In the encoding portion, as the number of network layers increases, the resolution of the feature maps is gradually decreased, and the number of feature maps is gradually increased, so that rich semantic features and image spatial features are obtained. In the decoding portion, the resolution of feature maps is gradually increased, and the resolution of the feature map finally output by the decoding portion is the same as that of the first depth map.

In some embodiments, fusion processing is performed on the first image and the first depth map to obtain a fusion result, and depth prediction values of a plurality of pixels in the first image are determined based on the fusion result.

In one example, the first image and the first depth map can be concated to obtain a fusion result.

In one example, convolutional processing is performed on the fusion result to obtain a second convolutional result. Down-sampling processing is performed based on the second convolutional result to obtain a first encoding result. Depth prediction values of the plurality of pixels in the first images are determined based on the first encoding result.

For example, convolutional processing is performed on the fusion result by means of the convolutional layer to obtain a second convolutional result.

For example, normalization processing is performed on the second convolutional result to obtain a second normalization result. Down-sampling processing is performed on the second normalization result to obtain a first encoding result. Here, normalization processing is performed on the second convolutional result by means of the normalization layer to obtain a second normalization result. Down-sampling processing is performed on the second normalization result by means of the down-sampling layer to obtain the first encoding result. Alternatively, down-sampling processing is performed on the second convolutional result by means of the down-sampling layer to obtain the first encoding result.

For example, deconvolution processing is performed on the first encoding result to obtain a first deconvolution result. Normalization processing is performed on the first deconvolution result to obtain a depth prediction value. Here, deconvolution processing is performed on the first encoding result by means of the deconvolution layer to obtain the first deconvolution result. Normalization processing is performed on the first deconvolution result by means of the normalization layer to obtain the depth prediction value. Alternatively, deconvolution processing is performed on the first encoding result by means of the deconvolution layer to obtain the depth prediction value.

For example, up-sampling processing is performed on the first encoding result to obtain a first up-sampling result. Normalization processing is performed on the first up-sampling result to obtain a depth prediction value. Here, up-sampling processing is performed on the first encoding result by means of the up-sampling layer to obtain a first up-sampling result. Normalization processing is performed on the first up-sampling result by means of the normalization layer to obtain the depth prediction value. Alternatively, up-sampling processing is performed on the first encoding result by means of the up-sampling layer to obtain the depth prediction value.

In addition, associated information of a plurality of pixels in the first image is obtained by processing the first image. The associated information of the plurality of pixels in the first image includes the degree of association between each pixel of the plurality of pixels in the first image and surrounding pixels thereof. The surrounding pixels of the pixel include at least one adjacent pixel of the pixel, or a plurality of pixels spaced apart from the pixel by a certain value. For example, as shown in FIG. 11, the surrounding pixels of pixel 5 include pixel 1, pixel 2, pixel 3, pixel 4, pixel 6, pixel 7, pixel 8 and pixel 9 which are adjacent to pixel 5. Accordingly, the associated information of the plurality of pixels in the first image includes the degree of association between pixel 1, pixel 2, pixel 3, pixel 4, pixel 6, pixel 7, pixel 8, and pixel 9 and pixel 5. As one example, the degree of association between the first pixel and the second pixel is measured by using the correlation between the first pixel and the second pixel. The embodiments of the present disclosure determine the correlation between pixels by using related technology, and details are not described herein again.

In the embodiments of the present disclosure, the associated information of the plurality of pixels is determined in multiple ways. In some embodiments, the first image is input to a degree-of-association detection neural network for processing to obtain the associated information of the plurality of pixels in the first image. For example, an associated feature map corresponding to the first image is obtained. Alternatively, associated information of the plurality of pixels may also be obtained by means of other algorithms, which is not limited in the embodiments of the present disclosure.

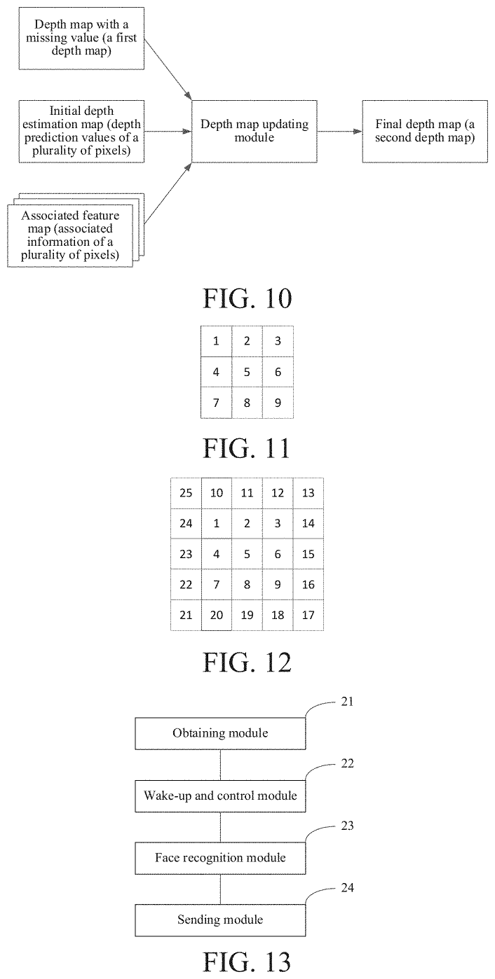

FIG. 9 shows a schematic diagram of a degree-of-association detection neural network in the vehicle door unlocking method according to embodiments of the present disclosure. As shown in FIG. 9. the first image is input to the degree-of-association detection neural network for processing, to obtain a plurality of associated feature maps. The associated information of the plurality of pixels in the first image is determined based on the plurality of associated feature maps. For example, if surrounding pixels of a certain pixel refer to pixels with the distance to the pixel equal to 0, that is, the surrounding pixels of the pixel refer to pixels adjacent to the pixel, the degree-of-association detection neural network outputs 8 associated feature maps. For example, in the first associated feature map, a pixel value of pixel P_{i,j}=the degree of association between pixel P_{i-1 j-1} and pixel P_{i,j} in the first image, where P_{i,j} represents the pixel in the i-th row and the j-th column. In the second associated feature map, the pixel value of pixel P_{i,j}=the degree of association between pixel Pᵢ₋₁₋ⱼ and pixel P_{i,j} in the first image. In the third associated feature map, the pixel value of pixel P_{i,j}=the degree of association between pixel P_{1-1 j+}1 and pixel P_{i,j} in the first image. In the fourth associated feature map, the pixel value of pixel P_{i,j}=the degree of association between pixel P_{i,j-1} and pixel P_{i,j} in the first image. In the fifth associated feature map, the pixel value of pixel P_{i,j}=the degree of association between pixel P_{i,j+1} and pixel P_{i,j} in the first image. In the sixth associated feature map, the pixel value of pixel P_{i,j}=the degree of association between pixel P_{i+1 j-1} and pixel P_{i,j} in the first image. In the seventh associated feature map, the pixel value of pixel P_{i,j}=the degree of association between pixel P_{i+1 j} and pixel P_{i,j} in the first image. In the eighth associated feature map, the pixel value of pixel P_{i,j}=the degree of association between pixel P_{1+1 j+1} and pixel P_{i,j} in the first image.

The degree-of-association detection neural network is implemented by means of multiple network structures. As one example, the degree-of-association detection neural network includes an encoding portion and a decoding portion. The encoding portion includes a convolutional layer and a down-sampling layer, and the decoding portion includes a deconvolution layer and/or an up-sampling layer. The encoding portion may also include a normalization layer, and the decoding portion may also include a normalization layer. In the encoding portion, the resolution of the feature maps is gradually reduced, and the number of feature maps is gradually increased, so as to obtain rich semantic features and image spatial features. In the decoding portion, the resolution of the feature maps is gradually increased, and the resolution of the feature maps finally output by the decoding portion is the same as that of the first image. In the embodiments of the present disclosure, the associated information may be an image or other data forms, such as a matrix.

As one example, inputting the first image to the degree-of-association detection neural network for processing to obtain the associated information of the plurality of pixels in the first image includes: performing convolutional processing on the first image to obtain a third convolutional result; performing down-sampling processing based on the third convolutional result to obtain a second encoding result; and obtaining associated information of the plurality of pixels in the first image based on the second encoding result.

In one example, convolutional processing is performed on the first image by means of the convolutional layer to obtain a third convolutional result.

In one example, performing down-sampling processing based on the third convolutional result to obtain the second encoding result includes: performing normalization processing on the third convolutional result to obtain a third normalization result; and performing down-sampling processing on the third normalization result to obtain the second encoding result. In this example, normalization processing is performed on the third convolutional result by means of a normalization layer to obtain a third normalization result. Down-sampling processing is performed on the third normalization result by means of a down-sampling layer to obtain a second encoding result. Alternatively, down-sampling processing is performed on the third convolutional result by means of the down-sampling layer to obtain the second encoding result.

In one example, determining the associated information based on the second encoding result includes: performing deconvolution processing on the second encoding result to obtain a second deconvolution result; and performing normalization processing on the second deconvolution result to obtain the associated information. In this example, deconvolution processing is performed on the second encoding result by means of the deconvolution layer to obtain the second deconvolution result. Normalization processing is performed on the second deconvolution result by means of the normalization layer to obtain the associated information. Alternatively, deconvolution processing is performed on the second encoding result by means of the deconvolution layer to obtain associated information.

In one example, determining the associated information based on the second encoding result includes: performing up-sampling processing on the second encoding result to obtain a second up-sampling result; and performing normalization processing on the second up-sampling result to obtain the associated information. In this example, up-sampling processing is performed on the second encoding result by means of the up-sampling layer to obtain a second up-sampling result. Normalization processing is performed on the second up-sampling result by means of the normalization layer to obtain the associated information. Alternatively, up-sampling processing is performed on the second encoding result by means of the up-sampling layer to obtain the associated information.

The current 3D sensors such as the TOF sensor and the structured light structure are susceptible to sunlight outside, which results in a large area of hole missing in the depth map, affecting the performance of 3D spoofing detection algorithms. The 3D spoofing detection algorithm based on depth map self-improvement proposed in the embodiments of the present disclosure improves the performance of the 3D spoofing detection algorithm by improving and repairing the depth map detected by the 3D sensor.

In some embodiments, after obtaining the depth prediction values and associated information of a plurality of pixels, update processing is performed on the first depth map based on the depth prediction values and associated information of the plurality of pixels to obtain a second depth map. FIG. 10 shows an exemplary schematic diagram of updating a depth map in the vehicle door unlocking method according to embodiments of the present disclosure. In the example shown in FIG. 10, the first depth map is a depth map with missing values, and the obtained depth prediction values and associated information of the plurality of pixels are an initial depth estimation map and an associated feature map, respectively. The depth map with missing values, the initial depth estimation map, and the associated feature map are input to a depth map update module (such as a depth update neural network) for processing to obtain a final depth map, that is, the second depth map.

In some embodiments, the depth prediction value of the depth invalidation pixel and the depth prediction values of surrounding pixels of the depth invalidation pixel are obtained from the depth prediction values of the plurality of pixels. The degree of association between the depth invalidation pixel and the plurality of surrounding pixels thereof is obtained from the associated information of the plurality of pixels. The updated depth value of the depth invalidation pixel is determined based on the depth predicted value of the depth invalidation pixel, the depth predicted values of the plurality of surrounding pixels of the depth invalidation pixel, and the degree of association between the depth invalidation pixel and the surrounding pixels thereof.

In the embodiments of the present disclosure, the depth invalidation pixels in the depth map are determined in multiple ways. As one example, a pixel having a depth value equal to 0 in the first depth map is determined as the depth invalidation pixel, or a pixel having no depth value in the first depth map is determined as the depth invalidation pixel.

In this example, for the valued part in the first depth map with missing values (that is, the depth value is not 0), it is believed that the depth value is correct and reliable. This part is not updated and the original depth value is retained. However, the depth value of the pixel with the depth value of 0 in the first depth map is updated.

As another example, the depth sensor may set the depth value of the depth invalidation pixel to one or more preset values or a preset range. In this example, a pixel with the depth value equal to a preset value or belonging to a preset range in the first depth map is determined as the depth invalidation pixel.

The embodiments of the present disclosure may also determine the depth invalidation pixels in the first depth map based on other statistical methods, which are not limited in the embodiments of the present disclosure.

In this implementation, the depth value of a pixel that has the same position as the depth invalidation pixel in the first image is determined as the depth prediction value of the depth invalidation pixel. Similarly, the depth value of a pixel that has the same position as the surrounding pixels of the depth invalidation pixel in the first image is determined as the depth prediction value of the surrounding pixels of the depth invalidation pixel.

As one example, the distance between the surrounding pixels of the depth invalidation pixel and the depth invalidation pixel is less than or equal to the first threshold.

FIG. 11 shows a schematic diagram of surrounding pixels in the vehicle door unlocking method according to embodiments of the present disclosure. For example, if the first threshold is 0, only neighboring pixels are used as surrounding pixels. For example, if the neighboring pixels of pixel 5 include pixel 1, pixel 2, pixel 3, pixel 4, pixel 6, pixel 7, pixel 8, and pixel 9, then only pixel 1, pixel 2, pixel 3, pixel 4, pixel 6, Pixels 7, 8 and 9 are used as the surrounding pixels of pixel 5.

FIG. 12 shows another schematic diagram of surrounding pixels in the vehicle door unlocking method according to embodiments of the present disclosure. For example, if the first threshold is 1, in addition to using neighboring pixels as surrounding pixels, neighboring pixels of neighboring pixels are also used as surrounding pixels. That is, in addition to using pixel 1, pixel 2, pixel 3, pixel 4. pixel 6, pixel 7, pixel 8, and pixel 9 as surrounding pixels of pixel 5, pixel 10 to pixel 25 are also used as surrounding pixels of pixel 5.

As one example, the depth association value of the depth invalidation pixel is determined based on the depth prediction values of the surrounding pixels of the depth invalidation pixel and the degree of association between the depth invalidation pixel and the plurality of surrounding pixels thereof. The updated depth value of the depth invalidation pixel is determined based on the depth prediction value and the depth association value of the depth invalidation pixel.

As another example, effective depth values of the surrounding pixels with respect to the depth invalidation pixel is determined based on the depth prediction values of the surrounding pixels of the depth invalidation pixel and the degree of association between the depth invalidation pixel and the surrounding pixels. The updated depth value of the depth invalidation pixel is determined based on the effective depth value of each surrounding pixel of the depth invalidation pixel with respect to the depth invalidation pixel and the depth prediction value of the depth invalidation pixel. For example, the product of the depth prediction value of a certain surrounding pixel of the depth invalidation pixel and the degree of association corresponding to the surrounding pixel is determined as the effective depth value of the surrounding pixel with respect to the depth invalidation pixel, where the degree of association corresponding to the surrounding pixel refers to the degree of association between the surrounding pixel and the depth invalidation pixel. For example, the product of the sum of the effective depth values of the surrounding pixels of the depth invalidation pixel with respect to the depth invalidation pixel and a first preset coefficient is determined to obtain a first product. The product of the depth prediction value of the depth invalidation pixel and a second preset coefficient is determined to obtain a second product. The sum of the first product and the second product is determined as the updated depth value of the depth invalidation pixel. In some embodiments, the sum of the first preset coefficient and the second preset coefficient is 1.

In one example, the degree of association between the depth invalidation pixel and each surrounding pixel is used as the weight of each surrounding pixel, and weighted summing processing is performed on the depth prediction values of the plurality of surrounding pixels of the depth invalidation pixel to obtain the depth association value of the depth invalidation pixel. For example, if pixel 5 is a. depth invalidation pixel, the depth association value of depth invalidation pixel 5 is

$${\sum }_{{1 \leq i \leq 9}_{i \neq 5 }} \frac{{w}_{i}}{W} F .$$

The updated depth value of depth invalidation pixel 5 is determined using Formula 7,

$${F}_{5}^{′} = {F}_{5} + {\sum }_{{1 \leq i \leq 9}_{i \neq 5 }} \frac{{w}_{i}}{W} F . \qquad Formula 7$$

In

$$W = {\sum }_{{1 \leq i \leq 9}_{i \neq 5 }} {w}_{i} ,$$

wᵢ represents the degree of association between pixel i and pixel 5, and Fᵢ represents the depth prediction value of pixel i.

In another example, the product of the degree of association between each of the plurality of surrounding pixels of the depth invalidation pixel and the depth invalidation pixel and the depth prediction value of each surrounding pixel is determined. The maximum value of the product is determined as the depth association value of the depth invalidation pixel.

In one example, the sum of the depth prediction value and the depth association value of the depth invalidation pixel is determined as the updated depth value of the depth invalidation pixel.

In another example, the product of the depth prediction value of the depth invalidation pixel and the third preset coefficient is determined to obtain a third product. The product of the depth association value and the fourth preset coefficient is obtained to obtain a fourth product. The sum of the third product and the fourth product is determined as the updated depth value of the depth invalidation pixel. In some embodiments, the sum of the third preset coefficient and the fourth preset coefficient is 1.

In some embodiments, a depth value of a non-depth invalidation pixel in the second depth map is equal to the depth value of the non-depth invalidation pixel in the first depth map.

In other embodiments, the depth value of the non-depth invalidation pixel may also be updated to obtain a more accurate second depth map, thereby further improving the accuracy of the spoofing detection.

In the embodiments of the present disclosure, a distance between a target object outside a vehicle and the vehicle is obtained by means of at least one distance sensor provided in the vehicle, in response to the distance satisfying a predetermined condition, an image collection module provided in the vehicle is waked up and controlled to collect a first image of the target object, face recognition is performed based on the first image, and in response to successful face recognition, a vehicle door unlocking instruction is sent to at least one vehicle door lock of the vehicle, thereby improving the convenience of vehicle door unlocking under the premise of ensuring the safety of vehicle door unlocking. With the embodiments of the present disclosure, when the vehicle owner approaches the vehicle, the spoofing detection and face authentication processes are automatically triggered without doing any actions (such as touching a button or making gestures), and the vehicle door automatically opens after the vehicle owner's spoofing detection and face authentication are successful.

In one possible implementation, after performing the face recognition based on the first image, the method further includes: in response to a face recognition failure, activating a password unlocking module provided in the vehicle to start a password unlocking process.

In this implementation, password unlocking is an alternative solution for face recognition unlocking, The reason why the face recognition fails may include at least one of the spoofing detection result being that the target object is spoofing, a face authentication failure, an image collection failure (such as a camera fault), or the number of recognitions exceeding a predetermined number. When the target object does not pass the face recognition, a password unlocking process is started. For example, the password entered by the user is obtained by means of a touch screen on the B-pillar. In one example, after consecutively entering the wrong password M times, the password unlocking fails, for example, M is equal to 5.

In one possible implementation, the method further includes one or both of the following: performing vehicle owner registration according to a face image of a vehicle owner collected by the image collection module; or performing remote registration according to the face image of the vehicle owner collected by a terminal device of the vehicle owner, and sending registration information to the vehicle, where the registration information includes the face image of the vehicle owner.

In one example, performing vehicle owner registration according to the face image of the vehicle owner collected by the image collection module includes: upon detecting that a registration button on the touch screen is clicked, requesting a user to enter a password; if the password authentication is successful, starting an RGB camera in the image collection module obtain the user's face image; and performing registration according to the obtained face image, and extracting a face feature in the face image as a pre-registered face feature, and performing face comparison based on the pre-registered face feature in subsequent face authentication.

In one example, remote registration is performed according to the face image of the vehicle owner collected by a terminal device of the vehicle owner, and registration information is sent to the vehicle, where the registration information includes the face image of the vehicle owner. In this example, the vehicle owner sends a registration request to a Telematics Service Provider (TSP) cloud by means of a mobile Application (App), where the registration request carries the face image of the vehicle owner. The TSP cloud sends the registration request to a vehicle-mounted Telematics Box (T-Box) of the vehicle door unlocking apparatus. The vehicle-mounted T-Box activates the face recognition function according to the registration request, and uses the face feature in the face image carried in the registration request as pre-registered face feature to perform face comparison based on the pre-registered face feature during subsequent face authentication.

It can be understood that the foregoing various method embodiments mentioned in the present disclosure may be combined with each other to form a combined embodiment without departing from the principle logic. Details are not described herein repeatedly due to space limitation.

A person skilled in the art can understand that, in the foregoing methods of the specific implementations, the order in which the steps are written does not imply a strict execution order which constitutes any limitation to the implementation process, and the specific order of executing the steps should be determined by functions and possible internal logics thereof.

In addition, the present disclosure further provides a vehicle door unlocking apparatus, an electronic device, a computer-readable storage medium, and a program, which can all be configured to implement any one of the vehicle door unlocking methods provided in the present disclosure. For corresponding technical solutions and descriptions, please refer to the corresponding content in the method section. Details are not described repeatedly.

FIG. 13 shows a block diagram of a vehicle door unlocking apparatus according to embodiments of the present disclosure. The apparatus includes: an obtaining module 21, configured to obtain a distance between a target object outside a vehicle and the vehicle by means of at least one distance sensor provided in the vehicle; a wake-up and control module 22, configured to wake up and control, in response to the distance satisfying a predetermined condition, an image collection module provided in the vehicle to collect a first image of the target object; a face recognition module 23, configured to perform face recognition based on the first image; and a sending module 24, configured to send, in response to successful face recognition, a vehicle door unlocking instruction to at least one vehicle door lock of the vehicle.

In the embodiments of the present disclosure, a distance between a target object outside a vehicle and the vehicle is obtained by means of at least one distance sensor provided in the vehicle, in response to the distance satisfying a predetermined condition, an image collection module provided in the vehicle is waked up and controlled to collect a first image of the target object, face recognition is performed based on the first image, and in response to successful face recognition, a vehicle door unlocking instruction is sent to at least one vehicle door lock of the vehicle, thereby improving the convenience of vehicle door unlocking under the premise of ensuring the safety of vehicle door unlocking.

In one possible implementation, the predetermined condition includes at least one of the following: the distance is less than a predetermined distance threshold; a duration in which the distance is less than the predetermined distance threshold reaches a predetermined time threshold; or the distance obtained in the duration indicates that the target object is proximate to the vehicle.

In one possible implementation, the at least one distance sensor includes a Bluetooth distance sensor. The obtaining module 21 is configured to: establish a Bluetooth pairing connection between an external device and the Bluetooth distance sensor; and in response to a successful Bluetooth pairing connection, obtain a first distance between the target object with the external device and the vehicle by means of the Bluetooth distance sensor.

In this implementation, the external device may be any Bluetooth-enabled mobile device. For example, the external device may be a mobile phone, a wearable device, or an electronic key, etc. The wearable device may be a smart bracelet or smart glasses.

In this implementation, by establishing a Bluetooth pairing connection between the external device and the Bluetooth distance sensor, a layer of authentication is added by means of Bluetooth, thereby improving the security of vehicle door unlocking.

In one possible implementation, the at least one distance sensor includes an ultrasonic distance sensor. The obtaining module 21 is configured to: obtain a second distance between the target object and the vehicle by means of the ultrasonic distance sensor provided on an outside of the vehicle.

In one possible implementation, the at least one distance sensor includes: a Bluetooth distance sensor and an ultrasonic distance sensor. The obtaining module 21 is configured to: establish the Bluetooth pairing connection between the external device and the Bluetooth distance sensor; in response to a successful Bluetooth pairing connection, obtain the first distance between the target object with the external device and the vehicle by means of the Bluetooth distance sensor; and obtain the second distance between the target object and the vehicle by means of the ultrasonic distance sensor. The wake-up and control module 22 is configured to wake up and control, in response to the first distance and the second distance satisfying the predetermined condition, the image collection module provided in the vehicle to collect the first image of the target object.

In this implementation, the security of vehicle door unlocking is improved by means of the cooperation of the Bluetooth distance sensor and the ultrasonic distance sensor.

In one possible implementation, the predetermined condition includes a first predetermined condition and a second predetermined condition. The first predetermined condition includes at least one of the following: the first distance is less than a predetermined first distance threshold; the duration in which the first distance is less than the predetermined first distance threshold reaches the predetermined time threshold; or the first distance obtained in the duration indicates that the target object is proximate to the vehicle. The second predetermined condition includes: the second distance is less than a predetermined second distance threshold; the duration in which the second distance is less than the predetermined second distance threshold reaches the predetermined time threshold; and the second distance threshold is less than the first distance threshold.

In one possible implementation, the wake-up and control module 22 includes: a wake-up sub-module, configured to wake up, in response to the first distance satisfying the first predetermined condition, a face recognition system provided in the vehicle; and a control sub-module, configured to control, in response to the second distance satisfying the second predetermined condition, the image collection module to collect the first image of the target object by means of the waked-up face recognition system.

The wake-up process of the face recognition system generally takes some time, for example, it takes 4 to 5 seconds, which makes the trigger and processing of face recognition slower, affecting the user experience. In the foregoing implementation, by combining the Bluetooth distance sensor and the ultrasonic distance sensor, when the first distance obtained by the Bluetooth distance sensor satisfies the first predetermined condition, the face recognition system is waked up so that the face recognition system is in a working state in advance. When the second distance obtained by the ultrasonic distance sensor satisfies the second predetermined condition, the face image processing is performed quickly by means of the face recognition system, thereby increasing the face recognition efficiency and improving the user experience.

In one possible implementation, the distance sensor is an ultrasonic distance sensor. The predetermined distance threshold is determined according to a calculated distance threshold reference value and a predetermined distance threshold offset value. The distance threshold reference value represents a reference value of a distance threshold between an object outside the vehicle and the vehicle. The distance threshold offset value represents an offset value of the distance threshold between the object outside the vehicle and the vehicle.

In one possible implementation, the predetermined distance threshold is equal to a difference between the distance threshold reference value and the predetermined distance threshold offset value.

In one possible implementation, the distance threshold reference value is a minimum value of an average distance value after the vehicle is turned off and a maximum vehicle door unlocking distance, where the average distance value after the vehicle is turned off represents an average value of distances between the object outside the vehicle and the vehicle within a specified time period after the vehicle is turned off.

In one possible implementation, the distance threshold reference value is periodically updated. By periodically updating the distance threshold reference value, different environments are adapted.

In one possible implementation, the distance sensor is an ultrasonic distance sensor. The predetermined time threshold is determined according to a calculated time threshold reference value and a time threshold offset value, where the time threshold reference value represents a reference value of a time threshold at which a distance between the object outside the vehicle and the vehicle is less than the predetermined distance threshold, and the time threshold offset value represents an offset value of the time threshold at which the distance between the object outside the vehicle and the vehicle is less than the predetermined distance threshold.

In one possible implementation, the predetermined time threshold is equal to the sum of the time threshold reference value and the time threshold offset value.

In one possible implementation, the time threshold reference value is determined according to one or more of a horizontal detection angle of the ultrasonic distance sensor, a detection radius of the ultrasonic distance sensor, an object size, and an object speed.

In one possible implementation, the apparatus further includes: a first determining module, configured to determine alternative reference values corresponding to different types of objects according to different types of object sizes, different types of object speeds, the horizontal detection angle of the ultrasonic distance sensor, and the detection radius of the ultrasonic distance sensor; and a second determining module, configured to determine the time threshold reference value from the alternative reference values corresponding to the different types of objects.

In one possible implementation, the second determining module is configured to: determine a maximum value among the alternative reference values corresponding to the different types of objects as the time threshold reference value.

In some embodiments, in order not to affect the experience, the predetermined time threshold is set to less than 1 second. In one example, the interference caused by pedestrians, bicycles, etc. is reduced by reducing the horizontal detection angle of the ultrasonic distance sensor.

in one possible implementation, the face recognition includes: spoofing detection and face authentication. The face recognition module 23 includes: a face authentication module, configured to collect the first image by means of an image sensor in the image collection module, and perform the face authentication based on the first image and a pre-registered face feature; and a spoofing detection module, configured to collect a first depth map corresponding to the first image by means of a depth sensor in the image collection module, and perform the spoofing detection based on the first image and the first depth map.

In this implementation, the spoofing detection is used to verify whether the target object is a human body, for example, it may be used to verify whether the target object is a human body. Face authentication is used to extract a face feature in the collected image, compare the face feature in the collected image with a pre-registered face feature, and determine whether the face features belong to the same person. For example, it may be determined whether the face feature in the collected image belongs to the face feature of the vehicle owner.

In one possible implementation, the spoofing detection module includes: an updating sub-module, configured to update the first depth map based on the first image to obtain a second depth map; and a determining sub-module, configured to determine a spoofing detection result of the target object based on the first image and the second depth map.

In one possible implementation, the image sensor includes an RGB image sensor or an IR sensor. The depth sensor includes a binocular IR sensor or a TOF sensor. The binocular IR sensor includes two IR cameras. The structured light sensor may be a coded structured light sensor or a speckle structured light sensor. The depth map of the target object is obtained by means of the depth sensor, and a high-precision depth map is obtained. The embodiments of the present disclosure use the depth map containing the target object for spoofing detection, which may fully mine the depth information of the target object, thereby improving the accuracy of the spoofing detection. For example, when the target object is a face, the embodiments of the present disclosure use the depth map containing the face to perform the spoofing detection, which may fully mine the depth information of the face data, thereby improving the accuracy of the spoofing face detection.

In one possible implementation, the TOF sensor uses a TOF module based on the IR band. By using the TOF module based on the IR band, the influence of external light on the depth map photographing may be reduced.

In one possible implementation, the updating sub-module is configured to: update a depth value of a depth invalidation pixel in the first depth map based on the first image to obtain the second depth map.

The depth invalidation pixel in the depth map refers to a pixel with an invalid depth value included in the depth map, i.e., a pixel with inaccurate depth value or apparently inconsistent with actual conditions. The number of depth invalidation pixels may be one or more. By updating the depth value of at least one depth invalidation pixel in the depth map, the depth value of the depth invalidation pixel is more accurate, which helps to improve the accuracy of the spoofing detection.

In one possible implementation, the updating sub-module is configured to: determine depth prediction values and associated information of a plurality of pixels in the first image based on the first image, where the associated information of the plurality of pixels indicates a degree of association between the plurality of pixels; and update the first depth map based on the depth prediction values and associated information of the plurality of pixels to obtain the second depth map.

In one possible implementation, the updating sub-module is configured to: determine the depth invalidation pixel in the first depth map; obtain a depth prediction value of the depth invalidation pixel and depth prediction values of a plurality of surrounding pixels of the depth invalidation pixel from the depth prediction values of the plurality of pixels; obtain the degree of association between the depth invalidation pixel and the plurality of surrounding pixels of the depth invalidation pixel from the associated information of the plurality of pixels; and determine an updated depth value of the depth invalidation value based on the depth prediction value of the depth invalidation pixel, the depth prediction values of the plurality of surrounding pixels of the depth invalidation pixel, and the degree of association between the depth invalidation pixel and the surrounding pixels of the depth invalidation pixel.

In one possible implementation, the updating sub-module is configured to: determine a depth association value of the depth invalidation pixel based on the depth prediction values of the surrounding pixels of the depth invalidation pixel and the degree of association between the depth invalidation pixel and the plurality of surrounding pixels of the depth invalidation pixel; and determine the updated depth value of the depth invalidation pixel based on the depth prediction value and the depth association value of the depth invalidation pixel.

In one possible implementation, the updating sub-module is configured to: use the degree of association between the depth invalidation pixel and each surrounding pixel as a weight of the each surrounding pixel, and perform weighted summing processing on the depth prediction values of the plurality of surrounding pixels of the depth invalidation pixel to obtain the depth association value of the depth invalidation pixel.

In one possible implementation, the updating sub-module is configured to: determine the depth prediction values of the plurality of pixels in the first image based on the first image and the first depth map.

In one possible implementation, the updating sub-module is configured to: input the first image and the first depth map to a depth prediction neural network for processing to obtain the depth prediction values of the plurality of pixels in the first image.

In one possible implementation, the updating sub-module is configured to: perform fusion processing on the first image and the first depth map to obtain a fusion result; and determine the depth prediction values of the plurality of pixels in the first image based on the fusion result.

In one possible implementation, the updating sub-module is configured to: input the first image to a degree-of-association detection neural network for processing to obtain the associated information of the plurality of pixels in the first image.

In one possible implementation, the updating sub-module is configured to: obtain an image of the target object from the first image; and update the first depth map based on the image of the target object.

In one possible implementation, the updating sub-module is configured to: obtain key point information of the target object in the first image; and obtain the image of the target object from the first image based on the key point information of the target object.

In one example, a contour of the target object is determined based on the key point information of the target object, and an image of the target object is captured from the first image according to the contour of the target object. Compared with the position information of the target object obtained by means of target detection, the position of the target object obtained by means of the key point information is more accurate, which is beneficial to improve the accuracy of subsequent spoofing detection.

In this way, by obtaining the image of the target object from the first image and performing the spoofing detection based on the image of the target object, it is possible to reduce the interference of the background information in the first image on the spoofing detection,

In one possible implementation, the updating sub-module is configured to: perform target detection on the first image to obtain a region where the target object is located; and perform key point detection on an image of the region where the target object is located to obtain the key point information of the target object in the first image.

In one possible implementation, the updating sub-module is configured to: obtain a depth map of the target object from the first depth map; and update the depth map of the target object based on the first image to obtain the second depth map.

In this way, the depth map of the target object is obtained from the first depth map, and the depth map of the target object is updated based on the first image to obtain a second depth map, thereby reducing interference of the background information in the first depth map on the spoofing detection.

In some specific scenarios (such as a scenario with strong light outside), the obtained depth map (such as the depth map collected by the depth sensor) may fail in some areas. In addition, under normal lighting, partial invalidation of the depth map may also be randomly caused by factors such as reflection of the glasses, black hair, or frames of black glasses. Moreover, some special paper may make the printed face photos have a similar effect of large area invalidation or partial invalidation of the depth map. In addition, by blocking an active light source of the depth sensor, the depth map may also partially fails, and the imaging of a spoofing object in the image sensor is normal. Therefore, in the case that some or all of the depth maps fail, the use of depth maps to distinguish between a non-spoofing object and the spoofing object causes errors. Therefore, in the embodiments of the present disclosure, by repairing or updating the first depth map, and using the repaired or updated depth map to perform spoofing detection, it is beneficial to improve the accuracy of the spoofing detection.

In one possible implementation, the determining sub-module is configured to: input the first image and the second depth map to a spoofing detection neural network for processing to obtain the spoofing detection result of the target object.

In one possible implementation, the determining sub-module is configured to: perform feature extraction processing on the first image to obtain first feature information; perform feature extraction processing on the second depth map to obtain second feature information; and determine the spoofing detection result of the target object based on the first feature information and the second feature information.

Optionally, the feature extraction processing may be implemented by means of a neural network or other machine learning algorithms, and the type of the extracted feature information may optionally be obtained by learning a sample, which is not limited in the embodiments of the present disclosure.

In one possible implementation, the determining sub-module is configured to: perform fusion processing on the first feature information and the second feature information to obtain third feature information; and determine the spoofing detection result of the target object based on the third feature information.

In one possible implementation, the determining sub-module is configured to: obtain a probability that the target object is non-spoofing based on the third feature information; and determine the spoofing detection result of the target object according to the probability that the target object is non-spooling.

In the embodiments of the present disclosure, a distance between a target object outside a vehicle and the vehicle is obtained by means of at least one distance sensor provided in the vehicle, in response to the distance satisfying a predetermined condition, an image collection module provided in the vehicle is waked up and controlled to collect a first image of the target object, face recognition is performed based on the first image, and in response to successful face recognition, a vehicle door unlocking instruction is sent to at least one vehicle door lock of the vehicle, thereby improving the convenience of vehicle door unlocking under the premise of ensuring the safety of vehicle door unlocking. With the embodiments of the present disclosure, when the vehicle owner approaches the vehicle, the spoofing detection and face authentication processes are automatically triggered without doing any actions (such as touching a button or making gestures), and the vehicle door automatically opens after the vehicle owner's spoofing detection and face authentication are successful.

In one possible implementation, the apparatus further includes: an activating and starting module, configured to activate, in response to a face recognition failure, a password unlocking module provided in the vehicle to start a password unlocking process.

In this implementation, password unlocking is an alternative solution for face recognition unlocking. The reason why the face recognition fails may include at least one of the spoofing detection result being that the target object is spoofing, a face authentication failure, an image collection failure (such as a camera fault), or the number of recognitions exceeding a predetermined number. When the target object does not pass the face recognition, a password unlocking process is started. For example, the password entered by the user is obtained by means of a touch screen on the B-pillar.

In one possible implementation, the apparatus further includes a registration module, configured to perform one or both of the following: performing vehicle owner registration according to a face image of a vehicle owner collected by the image collection module; or performing remote registration according to the face image of the vehicle owner collected by a terminal device of the vehicle owner, and sending registration information to the vehicle, where the registration information includes the face image of the vehicle owner.

By means of this implementation, face comparison is performed based on the pre-registered face feature in subsequent face authentication.

In some embodiments, the functions provided by or the modules included in the apparatuses provided in the embodiments of the present disclosure may be used to implement the methods described in the foregoing method embodiments. For specific implementations, reference may be made to the description in the method embodiments above. For the purpose of brevity, details are not described herein again.

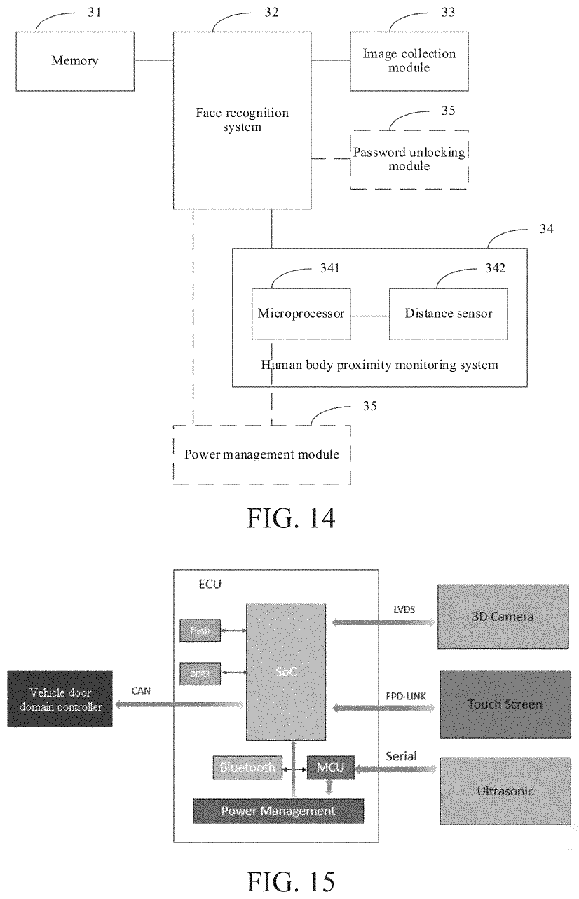

FIG. 14 shows a block diagram of a vehicle-mounted face unlocking system according to embodiments of the present disclosure. As shown in FIG. 14, the vehicle-mounted face unlocking system includes a memory 31, a face recognition system 32, an image collection module 33, and a human body proximity monitoring system 34. The face recognition system 32 is separately connected to the memory 31, the image collection module 33, and the human body proximity monitoring system 34. The human body proximity monitoring system 34 comprises a microprocessor 341 that wakes up the face recognition system if a distance satisfies a predetermined condition and at least one distance sensor 342 connected to the microprocessor 341. The face recognition system 32 is further provided with a communication interface connected to a. vehicle door domain controller. If face recognition is successful, control information for unlocking a vehicle door is sent to the vehicle door domain controller based on the communication interface.

In one example, the memory 31 includes at least one of a flash or a Double Date Rate 3 (DDR3) memory.

In one example, the face recognition system 32 may be implemented by a System on Chip (SoC).

In one example, the face recognition system 32 is connected to a vehicle door domain controller by means of a Controller Area Network (CAN) bus.

In one possible implementation, at least one distance sensor 342 includes at least one of the following: a Bluetooth distance sensor or an ultrasonic distance sensor.

In one example, the ultrasonic distance sensor is connected to the microprocessor 341 by means of a serial bus.

In one possible implementation, the image collection module 33 includes an image sensor and a depth sensor.

In one example, the image sensor includes at least one of an RGB sensor or an IR sensor.

In one example, the depth sensor includes at least one of a binocular infrared sensor or a TOF sensor.

In one possible implementation, the depth sensor includes a binocular infrared sensor, and two IR cameras of the binocular infrared sensor are provided on both sides of the camera of the image sensor. For example, in the example shown in FIG. 5a, the image sensor is an RGB sensor, the camera of the image sensor is an RGB camera, the depth sensor is a binocular IR sensor, the depth sensor includes two IR cameras, and the two IR cameras of the binocular IR sensor are located on both sides of the RGB camera of the image sensor.

In one example, the image collection module 33 further includes at least one fill light. The at least one fill light is provided between the IR camera of the binocular IR sensor and the camera of the image sensor. The at least one till light includes at least one of a fill light for the image sensor or a fill light for the depth sensor. For example, if the image sensor is an RGB sensor, the till light for the image sensor may be a white light. If the image sensor is an infrared sensor, the till light for the image sensor may be an lR light. If the depth sensor is binocular IR sensor, the fill light for the depth sensor may be an IR light. In the example shown in FIG. 5a, the IR light is provided between the IR camera of the binocular IR sensor and the camera of the image sensor. For example, the IR light uses IR ray at 940 nm.

In one example, the fill light may be in a normally-on mode. In this example, when the camera of the image collection module is in the working state, the fill light is in a turn-on state.

In another example, the fill light may be turned on when there is insufficient light. For example, the ambient light intensity is obtained by means of an ambient light sensor, and when the ambient light intensity is lower than a light intensity threshold, it is determined that the light is insufficient, and the fill light is turned on.

In one example, the image collection module 33 further includes a laser provided between the camera of the depth sensor and the camera of the image sensor. For example, in the example shown in FIG. 5b, the image sensor is an RGB sensor, the camera of the image sensor is an RGB camera, the depth sensor is a TOF sensor, and the laser is provided between the camera of the TOF sensor and the camera of the ROB sensor. For example, the laser may be a VCSEL, and the TOF sensor may collect a depth map based on the laser emitted by the VCSEL.

In one example, the depth sensor is connected to the face recognition system 32 by means of a Low-Voltage Differential Signaling (LVDS) interface.

In one possible implementation, the vehicle-mounted face unlocking system further includes a password unlocking module 35 configured to unlock a vehicle door. The password unlocking module 35 is connected to the face recognition system 32.

In one possible implementation, the password unlocking module 35 includes one or both of a touch screen or a keyboard.

In one example, the touch screen is connected to the face recognition system 32 by means of a Flat Panel Display Link (FPD-Link).

In one possible implementation, the vehicle-mounted face unlocking system further includes a power management module 36 separately connected to the microprocessor 341 and the face recognition system 32.

In one possible implementation, the memory 31, the face recognition system 32, the human proximity monitoring system 34, and the power management module 36 are provided on an Electronic Control Unit (ECU).

FIG. 15 shows a schematic diagram of a vehicle-mounted face unlocking system according to embodiments of the present disclosure. In the example shown in FIG. 15, the memory 31, the face recognition system 32, the human proximity monitoring system 34, and the power management module 36 are provided on the ECU. The face recognition system 32 is implemented by using the SoC. The memory 31 includes a flash and a DDR3 memory. At least one distance sensor 342 includes a Bluetooth distance sensor and an ultrasonic distance sensor. The image collection module 33 includes a depth sensor (3D Camera), The depth sensor is connected to the face recognition system 32 by means of the LVDS interface. The password unlocking module 35 includes a touch screen, The touch screen is connected to the face recognition system 32 by means of the FPD-Link, and the face recognition system 32 is connected to the vehicle door domain controller by means of the CAN bus.

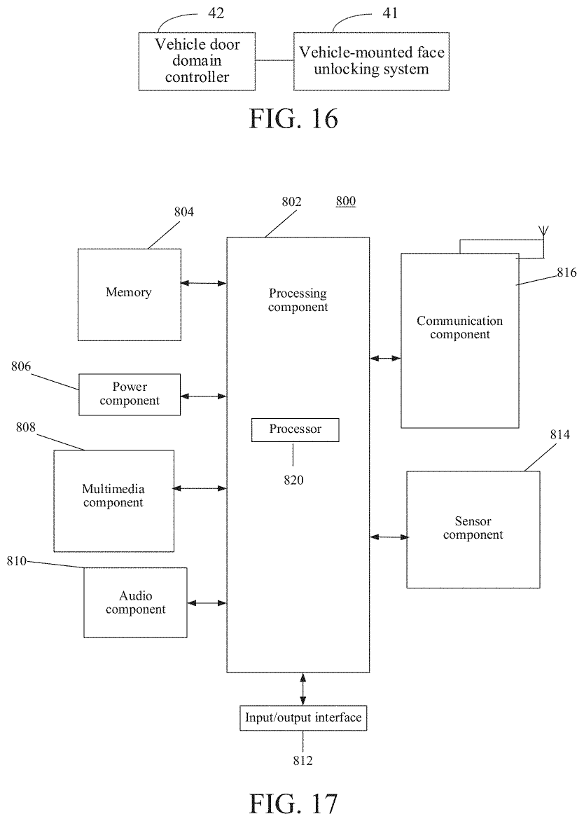

FIG. 16 shows a schematic diagram of a vehicle according to embodiments of the present disclosure. As shown in FIG. 16, the vehicle includes a vehicle-mounted face unlocking system 41. The vehicle-mounted face unlock system 41 is connected to the vehicle door domain controller 42 of the vehicle.

In one possible implementation, the image collection module is provided on an outside of the vehicle.

In one possible implementation, the image collection module is provided on at least one of the following positions: a B-pillar, at least one vehicle door, or at least one rearview mirror of the vehicle.

In one possible implementation, the face recognition system is provided in the vehicle, and is connected to the vehicle door domain controller by means of a CAN bus.

In one possible implementation, the at least one distance sensor includes a Bluetooth distance sensor provided in the vehicle.

In one possible implementation, the at least one distance sensor includes an ultrasonic distance sensor provided on an outside of the vehicle.

The embodiments of the present disclosure further provide a computer-readable storage medium, having computer program instructions stored thereon, where when the computer program instructions are executed by a processor, the foregoing method is implemented. The computer-readable storage medium may be a nonvolatile computer-readable storage medium or a volatile computer-readable storage medium.

The embodiments of the present disclosure also provide a computer program, including a computer-readable code, where when run in an electronic device, the computer-readable code is executed by a processor in the electrode device to implement the foregoing vehicle door unlocking method.

The embodiments of the present disclosure further provide an electronic device, including: a processor; and a memory configured to store processor-executable instructions, where the processor is configured to execute the foregoing method.

The electronic device may he provided as a terminal, a server, or other forms of devices.

FIG. 17 is a block diagram of an electronic device 800 according to an exemplary embodiment. For example, the electronic device 800 is a terminal such as the vehicle door unlocking apparatus.

Referring to FIG. 17, the electronic device 800 includes one or more of the following components: a processing component 802, a memory 804, a power supply component 806, a multimedia component 808, an audio component 810, an Input/Output (I/O) interface 812, a sensor component 814, and a communication component 816.

The processing component 802 generally controls overall operation of the electronic device 800, such as operations associated with display, phone calls, data communications, camera operations, and recording operations. The processing component 802 may include one or more processors 820 to execute instructions to implement all or some of the steps of the method above. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations on the electronic device 800. Examples of the data include instructions for any application or method operated on the electronic device 800, contact data, contact list data, messages, pictures, videos, and the like. The memory 804 is implemented by any type of volatile or non-volatile storage device or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or an optical disc.

The power supply component 806 provides power for various components of the electronic device 800. The power supply component 806 may include a power management system, one or more power supplies, and other components associated with power generation, management, and distribution for the electronic device 800.

The multimedia component 808 includes a screen between the electronic device 800 and a user that provides an output interface. In some embodiments, the screen may include a Liquid Crystal Display (LCD) and a Touch Panel (TP). If the screen includes a TP, the screen may be implemented as a touch screen to receive input signals from the user. The TP includes one or more touch sensors for sensing touches, swipes, and gestures on the TR The touch sensor may not only sense the boundary of a touch or swipe action, but also detect the duration and pressure related to the touch or swipe operation. In some embodiments, the multimedia component 808 includes a front-facing camera and/or a rear-facing camera. When the electronic device 800 is in an operation mode, for example, a photography mode or a video mode, the front-facing camera and/or the rear-facing camera may receive external multimedia data. Each of the front-facing camera and the rear-facing camera may be a fixed optical lens system, or have focal length and optical zoom capabilities.

The audio component 810 is configured to output and/or input an audio signal. For example, the audio component 810 includes a microphone (MIC), and the microphone is configured to receive an external audio signal when the electronic device 800 is in an operation mode, such as a calling mode, a recording mode, and a voice recognition mode. The received audio signal may be further stored in the memory 804 or sent by means of the communication component 816. In some embodiments, the audio component 810 further includes a speaker for outputting an audio signal.

The I/O interface 812 provides an interface between the processing component 802 and a peripheral interface module, and the peripheral interface module is a keyboard, a click wheel, a button, or the like. The button may include, but is not limited to, a home button, a volume button, a start button, and a lock button.

The sensor component 814 includes one or more sensors for providing state assessment in various aspects for the electronic device 800. For example, the sensor component 814 may detect an on/off state of the electronic device 800, and relative positioning of components, which are the display and keypad of the electronic device 800, for example, and the sensor component 814 may further detect a position change of the electronic device 800 or a component of the electronic device 800, the presence or absence of contact of the user with the electronic device 800, the orientation or acceleration/deceleration of the electronic device 800, and a temperature change of the electronic device 800. The sensor component 814 may include a proximity sensor, which is configured to detect the presence of a nearby object when there is no physical contact. The sensor component 814 may further include a light sensor, such as a CMOS or CCD image sensor, for use in an imaging application. In some embodiments, the sensor component 814 may further include an acceleration sensor, a gyroscope sensor, a magnetic sensor, a pressure sensor, or a temperature sensor.

The communication component 816 is configured to facilitate wired or wireless communications between the electronic device 800 and other devices. The electronic device 800 may access a wireless network based on a communication standard, such as WiFi, 2G, or 3G, 4G, or 5G, or a combination thereof. In one exemplary embodiment, the communication component 816 receives a broadcast signal or broadcast-related information from an external broadcast management system by means of a broadcast channel. In one exemplary embodiment, the communication component 816 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies,

In an exemplary embodiment, the electronic device 800 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic elements, to execute the method above.

In an exemplary embodiment, further provided is a non-volatile computer-readable storage medium, for example, a memory 804 including computer program instructions, which can executed by the processor 820 of the electronic device 800 to implement the method above.

The present disclosure may be a system, a method, and/or a computer program product. The computer program product may include a computer-readable storage medium, on which computer-readable program instructions used by the processor to implement various aspects of the present disclosure are stored.

The computer-readable storage medium may be a tangible device that can maintain and store instructions used by an instruction execution device. The computer-readable storage medium may be, but is not limited to, an electronic storage device, a magnetic storage device, an optical storage device, an electromagnetic storage device, a semiconductor storage device, or any suitable combination of the foregoing. More specific examples (a non-exhaustive list) of the computer-readable storage medium include a portable computer disk, a hard disk, a Random Access Memory (RAM), a Read-Only Memory (ROM), an Erasable Programmable Read-Only Memory (EPROM or flash memory), a Static Random Access Memory (SRAM), a portable Compact Disc Read-Only Memory (CD-ROM), a Digital Versatile Disk (DVD), a memory stick, a floppy disk, a mechanical coding device such as a punched card storing an instruction or a protrusion structure in a groove, and any appropriate combination thereof. The computer-readable storage medium used here is not interpreted as an instantaneous signal such as a radio wave or other freely propagated electromagnetic wave, an electromagnetic wave propagated by a waveguide or other transmission media (for example, an optical pulse transmitted by an optical fiber cable), or an electrical signal transmitted by a wire.

The computer-readable program instruction described here is downloaded to each computing/processing device from the computer-readable storage medium, or downloaded to an external computer or an external storage device via a network, such as the Internet, a Local Area Network (LAN), a Wide Area Network (WAN), and/or a wireless network. The network may include a copper transmission cable, optical fiber transmission, wireless transmission, a router, a firewall, a switch, a gateway computer, and/or an edge server. A network adapter card or a network interface in each computing/processing device receives the computer-readable program instruction from the network, and forwards the computer-readable program instruction, so that the computer-readable program instruction is stored in a computer-readable storage medium in each computing/processing device.

Computer program instructions for carrying out operations of the present disclosure may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions can be completely executed on a user computer, partially executed on a user computer, executed as an independent software package, executed partially on a user computer and partially on a remote computer, or completely executed on a remote computer or a server. In the case of a remote computer, the remote computer may be connected to a user computer via any type of network, including an LAN or a WAN, or may be connected to an external computer (for example, connected via the Internet with the aid of an Internet service provider). In some embodiments, an electronic circuit such as a programmable logic circuit, a Field Programmable Gate Array (FPGA), or a Programmable Logic Array (PLA) is personalized by using status information of the computer-readable program instructions, and the electronic circuit can execute the computer-readable program instructions to implement various aspects of the present disclosure.

Various aspects of the present disclosure are described here with reference to the flowcharts and/or block diagrams of the methods, apparatuses (systems), and computer program products according to the embodiments of the present disclosure. It should be understood that each block in the flowcharts and/or block diagrams and a combination of the blocks in the flowcharts and/or block diagrams can be implemented with the computer-readable program instructions.

These computer-readable program instructions may be provided for a general-purpose computer, a dedicated computer, or a processor of other programmable data processing apparatus to generate a machine, so that when the instructions are executed by the computer or the processors of other programmable data processing apparatuses, an apparatus for implementing a specified function/action in one or more blocks in the flowcharts and/or block diagrams is generated. These computer-readable program instructions may also be stored in a computer-readable storage medium, and these instructions instruct a computer, a programmable data processing apparatus, and/or other devices to work in a specific manner. Therefore, the computer-readable storage medium having the instructions stored thereon includes a manufacture, and the manufacture includes instructions in various aspects for implementing the specified function/action in the one or more blocks in the flowcharts and/or block diagrams.

The computer-readable program instructions may also be loaded onto a computer, other programmable data processing apparatuses, or other devices, so that a series of operation steps are executed on the computer, the other programmable apparatuses, or the other devices, thereby generating a computer-implemented process. Therefore, the instructions executed on the computer, the other programmable apparatuses, or the other devices implement the specified function/action in the one or more blocks in the flowcharts and/or block diagrams.

The flowcharts and block diagrams in the accompanying drawings show architectures, functions, and operations that may be implemented by the systems, methods, and computer program products in the embodiments of the present disclosure. In this regard, each block in the flowcharts or block diagrams may represent a module, a program segment, or a part of instruction, and the module, the program segment, or the part of instruction includes one or more executable instructions for implementing a specified logical function. In some alternative implementations, the functions noted in the block may also occur out of the order noted in the accompanying drawings. For example, two consecutive blocks are actually executed substantially in parallel, or are sometimes executed in a reverse order, depending on the involved functions. It should also be noted that each block in the block diagrams and/or flowcharts and a combination of blocks in the block diagrams and/or flowcharts may be implemented by using a dedicated hardware-based system configured to execute specified functions or actions, or may be implemented by using a combination of dedicated hardware and computer instructions.

The embodiments of the present disclosure are described above. The foregoing descriptions are exemplary but not exhaustive, and are not limited to the disclosed embodiments. Many modifications and variations will be apparent to a person of ordinary skill in the art without departing from the scope and spirit of the described embodiments. The terminology used herein was chosen to best explain the principles of the embodiments, the practical application or technical improvement over technologies found in the marketplace, or to enable other persons of ordinary skill in the art to understand the embodiments disclosed herein.

1. A vehicle door unlocking method, comprising:
obtaining a distance between a target object outside a vehicle and the vehicle by means of at least one distance sensor provided in the vehicle;
in response to the distance satisfying a predetermined condition, waking up and controlling an image collection module provided in the vehicle to collect a first image of the target object;
performing face recognition based on the first image; and
in response to successful face recognition, sending a vehicle door unlocking instruction to at least one vehicle door lock of the vehicle.

2. The method according to claim 1, wherein the predetermined condition comprises at least one of the following:
the distance is less than a predetermined distance threshold;
a duration in which the distance is less than the predetermined distance threshold reaches a predetermined time threshold; or
the distance obtained in the duration indicates that the target object is proximate to the vehicle.

3. The method according to claim 1, wherein the at least one distance sensor comprises a Bluetooth distance sensor,
obtaining the distance between the target object outside the vehicle and the vehicle by means of the at least one distance sensor provided in the vehicle comprises:
establishing a Bluetooth pairing connection between an external device and the Bluetooth distance sensor, and
in response to a successful Bluetooth pairing connection, obtaining a first distance between the target object with the external device and the vehicle by means of the Bluetooth distance sensor; and/or
wherein the at least one distance sensor comprises an ultrasonic distance sensor,
obtaining the distance between the target object outside the vehicle and the vehicle by means of the at least one distance sensor provided in the vehicle comprises:
obtaining a second distance between the target object and the vehicle by means of the ultrasonic distance sensor provided on an outside of the vehicle; and/or
wherein the at least one distance sensor comprises: a Bluetooth distance sensor and an ultrasonic distance sensor,
obtaining the distance between the target object outside the vehicle and the vehicle by means of the at least one distance sensor provided in the vehicle comprises: establishing the Bluetooth pairing connection between the external device and the Bluetooth distance sensor; in response to a successful Bluetooth pairing connection, obtaining the first distance between the target object with the external device and the vehicle by means of the Bluetooth distance sensor; and obtaining the second distance between the target object and the vehicle by means of the ultrasonic distance sensor, and
in response to the distance satisfying the predetermined condition, waking up and controlling the image collection module provided in the vehicle to collect the first image of the target object comprises: in response to the first distance and the second distance satisfying the predetermined condition, waking up and controlling the image collection module provided in the vehicle to collect the first image of the target object.

4. The method according to claim 3, wherein the predetermined condition comprises a first predetermined condition and a second predetermined condition,
the first predetermined condition comprises at least one of the following: the first distance is less than a predetermined first distance threshold; the duration in which the first distance is less than the predetermined first distance threshold reaches the predetermined time threshold; or the first distance obtained in the duration indicates that the target object is proximate to the vehicle,
the second predetermined condition comprises: the second distance is less than a predetermined second distance threshold; the duration in which the second distance is less than the predetermined second distance threshold reaches the predetermined time threshold; and the second distance threshold is less than the first distance threshold; and/or
wherein in response to the first distance and the second distance satisfying the predetermined condition, waking up and controlling the image collection module provided in the vehicle to collect the first image of the target object comprises:
in response to the first distance satisfying the first predetermined condition, waking up a face recognition system provided in the vehicle, and
in response to the second distance satisfying the second predetermined condition, controlling the image collection module to collect the first image of the target object by means of a waked-up face recognition system.

5. The method according to claim 2, wherein the distance sensor is an ultrasonic distance sensor; the predetermined distance threshold is determined according to a calculated distance threshold reference value and a predetermined distance threshold offset value; the distance threshold reference value represents a reference value of a distance threshold between an object outside the vehicle and the vehicle; and the distance threshold offset value represents an offset value of the distance threshold between the object outside the vehicle and the vehicle.

6. The method according to claim 5, wherein the predetermined distance threshold is equal to a difference between the distance threshold reference value and the predetermined distance threshold offset value; and/or
wherein the distance threshold reference value is a minimum value of an average distance value after the vehicle is turned off and a maximum vehicle door unlocking distance, wherein the average distance value after the vehicle is turned off represents an average value of distances between the object outside the vehicle and the vehicle within a specified time period after the vehicle is turned off; and/or
wherein the distance threshold reference value is periodically updated.

7. The method according to claim 2, wherein the distance sensor is an ultrasonic distance sensor; the predetermined time threshold is determined according to a calculated time threshold reference value and a time threshold offset value, wherein the time threshold reference value represents a reference value of a time threshold at which a distance between the object outside the vehicle and the vehicle is less than the predetermined distance threshold, and the time threshold offset value represents an offset value of the time threshold at which the distance between the object outside the vehicle and the vehicle is less than the predetermined distance threshold.

8. The method according to claim 7, wherein the predetermined time threshold is equal to a sum of the time threshold reference value and the time threshold offset value; and/or
wherein the time threshold reference value is determined according to one or more of a horizontal detection angle of the ultrasonic distance sensor, a detection radius of the ultrasonic distance sensor, an object size, and an object speed.

9. The method according to claim 8, further comprising:
determining alternative reference values corresponding to different types of objects according to different types of object sizes, different types of object speeds, the horizontal detection angle of the ultrasonic distance sensor, and the detection radius of the ultrasonic distance sensor; and
determining the time threshold reference value from the alternative reference values corresponding to the different types of objects.

10. The method according to claim 9, wherein determining the time threshold reference value from the alternative reference values corresponding to the different types of objects comprises:
determining a maximum value among the alternative reference values corresponding to the different types of objects as the time threshold reference value.

11. The method according to claim 1, wherein the face recognition comprises: spoofing detection and face authentication;
performing the face recognition based on the first image comprises:
collecting, by an image sensor in the image collection module, the first image, and performing the face authentication based on the first image and a pre-registered face feature; and
collecting, by a depth sensor in the image collection module, a first depth map corresponding to the first image, and performing the spoofing detection based on the first image and the first depth map.

12. The method according to claim 11, wherein performing the spoofing detection based on the first image and the first depth map comprises:
updating the first depth map based on the first image to obtain a second depth map; and
determining a spoofing detection result of the target object based on the first image and the second depth map.

13. The method according to claim 12, wherein updating the first depth map based on the first image to obtain the second depth map comprises:
updating a depth value of a depth invalidation pixel in the first depth map based on the first image to obtain the second depth map; and/or
wherein updating the first depth map based on the first image to obtain the second depth map comprises:
determining depth prediction values and associated information of a plurality of pixels in the first image based on the first image, wherein the associated information of the plurality of pixels indicates a degree of association between the plurality of pixels, and
updating the first depth map based on the depth prediction values and associated information of the plurality of pixels to obtain the second depth map.

14. The method according to claim 13, wherein updating the first depth map based on the depth prediction values and associated information of the plurality of pixels to obtain the second depth map comprises:
determining the depth invalidation pixel in the first depth map,
obtaining a depth prediction value of the depth invalidation pixel and depth prediction values of a plurality of surrounding pixels of the depth invalidation pixel from the depth prediction values of the plurality of pixels,
obtaining the degree of association between the depth invalidation pixel and the plurality of surrounding pixels of the depth invalidation pixel from the associated information of the plurality of pixels, and
determining an updated depth value of the depth invalidation value based on the depth prediction value of the depth invalidation pixel, the depth prediction values of the plurality of surrounding pixels of the depth invalidation pixel, and the degree of association between the depth invalidation pixel and the surrounding pixels of the depth invalidation pixel; and/or
wherein determining the depth prediction values of the plurality of pixels in the first image based on the first image comprises:
determining the depth prediction values of the plurality of pixels in the first image based on the first image and the first depth map; and/or
wherein determining the associated information of the plurality of pixels in the first image based on the first image comprises:
inputting the first image to a degree-of-association detection neural network for processing to obtain the associated information of the plurality of pixels in the first image.

15. The method according to claim 14, wherein determining the updated depth value of the depth invalidation value based on the depth prediction value of the depth invalidation pixel, the depth prediction values of the plurality of surrounding pixels of the depth invalidation pixel, and the degree of association between the depth invalidation pixel and the surrounding pixels of the depth invalidation pixel comprises:
determining a depth association value of the depth invalidation pixel based on the depth prediction values of the surrounding pixels of the depth invalidation pixel and the degree of association between the depth invalidation pixel and the plurality of surrounding pixels of the depth invalidation pixel; and
determining the updated depth value of the depth invalidation pixel based on the depth prediction value and the depth association value of the depth invalidation pixel.

16. The method according to claim 12, wherein updating the first depth map based on the first image comprises:
performing target detection on the first image to obtain a region where the target object is located;
performing key point detection on an image of the region where the target object is located to obtain the key point information of the target object in the first image;
obtaining the image of the target object from the first image based on the key point information of the target object; and
updating the first depth map based on the image of the target object.

17. The method according to claim 12, wherein updating the first depth map based on the first image to obtain the second depth map comprises:
obtaining a depth map of the target object from the first depth map, and
updating the depth map of the target object based on the first image to obtain the second depth map; and/or
wherein determining the spoofing detection result of the target object based on the first image and the second depth map comprises:
inputting the first image and the second depth map to a spoofing detection neural network for processing to obtain the spoofing detection result of the target object; and/or
wherein determining the spoofing detection result of the target object based on the first image and the second depth map comprises:
performing feature extraction processing on the first image to obtain first feature information,
performing feature extraction processing on the second depth map to obtain second feature information, and
determining the spoofing detection result of the target object based on the first feature information and the second feature information.

18. The method according to claim 17, wherein determining the spoofing detection result of the target object based on the first feature information and the second feature information comprises:
performing fusion processing on the first feature information and the second feature information to obtain third feature information;
obtaining a probability that the target object is non-spoofing based on the third feature information; and
determining the spoofing detection result of the target object according to the probability that the target object is non-spoofing.

19. An electronic device, comprising:
a processor; and
a memory configured to store processor-executable instructions;
wherein the processor is configured to invoke the instructions stored in the memory, so as to:
obtain a distance between a target object outside a vehicle and the vehicle by means of at least one distance sensor provided in the vehicle;
in response to the distance satisfying a predetermined condition, wake up and control an image collection module provided in the vehicle to collect a first image of the target object;
perform face recognition based on the first image; and
in response to successful face recognition, send a vehicle door unlocking instruction to at least one vehicle door lock of the vehicle.

20. A non-transitory computer-readable storage medium, having computer program instructions stored thereon, wherein when the computer program instructions are executed by a processor, the processor is caused to perform the operations of:
obtaining a distance between a target object outside a vehicle and the vehicle by means of at least one distance sensor provided in the vehicle;
in response to the distance satisfying a predetermined condition, waking up and controlling an image collection module provided in the vehicle to collect a first image of the target object;
performing face recognition based on the first image; and
in response to successful face recognition, sending a vehicle door unlocking instruction to at least one vehicle door lock of the vehicle.
